(19) United States
(12) Patent Application Publication
(10) Pub. No.: US 2006/0072014 A1
(43) Pub. Date: Apr. 6, 2006

(54) Smart optical sensor (SOS) hardware and software platform

(76) Inventors: Z. Jason Geng, Rockville, MD (US); Charles David Tunnell, Palm Bay, FL (US); Kfir Meidav, Baltimore, MD (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/196,748

(22) Filed: Aug. 2, 2005

Related U.S. Application Data
(60) Provisional application No. 60/598,101, filed on Aug. 2, 2004.

(51) Int. Cl. H04N 7/18; H04N 9/47

(52) U.S. Cl. 348/159; 348/143

(57) ABSTRACT

An improved optical sensor comprising at least one optical camera for collecting intelligence data, a control station associated with at least one of said cameras for detecting activities to be monitored and for selectively activating at least one of said cameras, and a computerized data processing apparatus for substantially reducing data transmission bandwidth requirements by preprocessing at least some of said intelligence data at said camera site before transmission from said surveillance camera to one or more remote control stations.

### RELATED APPLICATIONS

The present application claims priority under 35 U.S.C. § 119(e) from the following previously-filed Provisional Patent Applications, U.S. Application No. 60/598,101, filed Aug. 2, 2004 by Geng, entitled “Smart Optical Sensor (SOS) Hardware and Software Platform”.

### BACKGROUND

Existing video surveillance networks employ multiple visible and infrared video cameras connected to one or a few central control stations where motion detection and digital video recording takes place. This centralized video surveillance paradigm fails to meet the ever increasing demands of homeland security.

The threat of terrorism toward the United States has presented a pressing need for both government agencies and corporations alike to take a serious look at improving security postures on a 24 hour, 7 days a week operational basis. Ports, borders, sensitive facilities, shopping centers, and airports are all examples of areas that require continuous physical security monitoring. Existing intrusion-detection and surveillance approaches used today are typically labor intensive and involve a complex interconnection of commercial, off-the-shelf (COTS) products. These cameras, seismic, magnetic, acoustic, and trip wire sensors are awkward to deploy, manage, and operate. Deployment issues are exacerbated when surveillance coverage for large, remote geographic areas is required. Such geographic areas demand surveillance “sensors” spread across a large terrain, with numerous long and expensive cables used to connect all of these sensors as a system.

Traditional video surveillance consists of a complex array of closed-circuit television (CCTV) cameras, sensors, displays, and associated cabling that make installation, operation and maintenance difficult.

A practical, scalable security system is needed that allows users to quickly mount detection sensors in any environment and that can remotely detect unauthorized entry of materials and individuals and report the entry to the proper individuals for appropriate response. Such a distributed architecture would allow law enforcement agencies to manage limited resources much more effectively, providing a comprehensive and reliable surveillance capability that is easy to deploy and easy to use.

Of all the technologies available, video surveillance provides the most promise for physical security applications. No other sensor technology allows users to visually record and verify an intrusion in order to make an intelligent threat assessment. In addition, video surveillance does not require subjects to be cooperative and can be performed from a distance without detection. However, even with its tremendous advantages, traditional video surveillance has several limitations.

The use of motion detection devices in traditional video surveillance is plagued with a myriad of issues even with the recent advances made to improve the reliability of it. The commercial market has traditionally used “triggers” such as ultrasound or passive infrared (IR) detectors to trigger the camera when motion has occurred, however, environmental issues such as wind and animals can cause false alarms.

Multiple Target Tracking, which is the ability to track multiple targets and make sense of each target is also limited because of it's restricted viewing angels.

A severe limitation to rural and tactical perimeter security requirements is a camera's power requirements. The power a camera assembly draws off limits deployment locations to areas that can provide sufficient power.

Cabling also hampers situations where cameras are to be deployed and removed in an expeditious manner. Camera systems generally have complex cabling issues that are impractical for rural or large geographic area surveillance where the cameras may be far apart from one another.

In many instances, a camera system is mounted on a moving platform, such as a ground vehicle, a ship, or an airplane. Often this mounted system causes frame jitter and this frame jitter reduces image quality, and thus causes surveillance failures, such as false alarms, or unidentified events.

Ideally a surveillance system should require human intervention only when an event occurs. Furthermore, with algorithmic advances many events can and should be addressed by the system without user intervention.

Optical sensors may be classified into three categories: infrared (IR), Intensified Imager (I²), and visible. There are several trends in sensor development, such as resolution enhancements stemming from advanced sensor material technologies and manufacturing processes. For example, IR sensors are rapidly advancing into 640×480 resolutions through new research into thermal sensor technologies. Microcantilever sensors pose one new IR sensor approach with great potential for increasing image resolution and sensitivity over current microbolometer or Barium Strontium Titanaate (BST) sensors.

Visible image Complementary Metal-Oxide Semiconductor (CMOS) sensors are leading a digital revolution in surveillance applications. CMOS sensors, when compared to Charge Couple Device (CCD) sensors, offer higher resolutions, higher frame rates, and higher signal to noise ratios, all at a lower cost. Nonetheless, CCD cameras do offer a higher immunity to noise during long exposures, and hence better performance in low lighting scenarios. While traditional CCD cameras offer a typical resolution of 640×480 pixels with a maximum of 30 frames per second, CMOS cameras have achieved 4 mega-pixels per frame at rates as high as 240 frames per second.

### SUMMARY

In one of many possible embodiments, the present system and method provides an improved optical sensor comprising at least one optical camera for collecting intelligence data, a control station associated with one of said cameras for detecting activities to be monitored and for selectively activating one of said camera, and a computerized data processing apparatus for substantially reducing data transmission bandwidth requirements by preprocessing at least some of said intelligence data at said camera site before transmission from said surveillance camera to one or more remote control stations.

Another embodiment of the present system and method provides a video surveillance system comprising: an array of closed-circuit (CCTV) cameras, an array of computerized image processors individually associated with ones of said cameras in a distributed computing architecture, and a selectable array of algorithms for enabling any single said image processors to pre-process surveillance data from its associated camera to significantly reduce data transmission bandwidth requirements to facilitate improved video data transmission from said individual cameras to selectable ones of said control stations.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the system and method.

FIG. 1 depicts an architectural layout of a Smart Optical Sensor (SOS).

FIG. 2 is a table containing a brief summary of currently available optical cameras.

FIGS. 3A and 3B are pictures showing examples of an automatic feature point extraction for inter-frame registration for video stabilization.

FIG. 4A is a picture of a 128×128 single frame photograph.

FIG. 4B is a 1024×1024 composite of 100 frames obtained via a high frame rate captures from Complementary Metal-Oxide Semiconductor (CMOS) cameras using a super-sampling algorithm.

FIG. 5 is a set of video sequences demonstrating frame progression with multiple target tracking.

FIG. 6A is a single frame capture illustrating a directional dual alarm trip wire algorithm.

FIG. 6B is a single frame capture demonstrating a specified ‘ignore’ zone, such as a legitimate high activity zone.

FIG. 7 is a functional block diagram of the Smart Optical Sensor (SOS).

FIG. 8 is a functional block diagram depicting the Smart Optical Sensor (SOS) architecture.

FIG. 9 is a block diagram depicting the general Real-time algorithm development.

FIG. 10 is a block diagram depicting one embodiment of the Real-time algorithm development.

FIG. 11 is a block diagram demonstrating a top-level view of the Hierarchical Processing-Descriptive Block Diagram (HP-DBD) diagram associated with the algorithms to be ported onto the Smart Optical Sensor (SOS).

FIG. 12 is a block diagram demonstrating the implementation of algorithms on the Smart Optical Sensor (SOS), using the RAPID-Vbus.

FIG. 13 is a chart explaining the flexible real-time matrix inter-connects provided by the RAPID-Vbus.

FIG. 14 is a block diagram describing the functions of the Smart Optical Sensor (SOS).

FIG. 15 is a block diagram reiterating the detailed SmartDetect flow chart.

FIG. 16 is a block diagram of the CORUS for multi-modality breast imaging.

FIG. 17 shows a flow chart of finite element based image reconstruction algorithm.

FIG. 18 is a block diagram depicting the hardware architecture for the CORUS.

FIG. 19 illustrates the idea of the division of data into layers with the data partitioning among processors.

FIG. 20 illustrates the idea of ghost layers with the data partitioning among processors.

Throughout the drawings, identical reference numbers designate similar, but not necessarily identical, elements.

### DETAILED DESCRIPTION

The present specification discloses a method and system of providing an optical sensor. More specifically, the present specification discloses a surveillance system with a computerized data processing apparatus for substantially reducing data transmission bandwidth requirements.

In the following description, for purposes of explanation, numerous specific details are set forth in order to provide a thorough understanding of the present system and method for providing a surveillance system with a computerized data processing apparatus for substantially reducing data transmission bandwidth requirements. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Traditional video surveillance consists of a complex array of closed-circuit television (CCTV) cameras (102), sensors (105), displays, and associated cabling that make installation, operation and maintenance difficult.

One key advantage of the Smart Optical Sensor (SOS) (101) is that it provides a flexible, open architecture (100) that seamlessly and easily integrates into existing surveillance systems. Another key innovation introduced through the Smart Optical Sensor (SOS) (101) is the low-cost, low-power addition of computer vision to new and existing surveillance systems. The SOS (101) enables the embedding of computer vision image processing using any or all of three strategies for intelligent surveillance:
1. At the Camera (102)
2. Near Several Cameras (102) Protecting a Zone
3. In the Central Control Workstation (103)

With a distributed computing architecture (100), it is also possible to enhance redundancy and reliability by spreading the detection ‘intelligence’ across a wider surveillance area. Terrorists can no longer cut power to one Network Operation Center (NOC) or control station (103) and escape detection. Any security officer with a mobile wireless device, such as a Personal Digital Assistant (PDA), is alerted when events occur. Events are generated by the SOS (101) which are strategically embedded into the surveillance system.

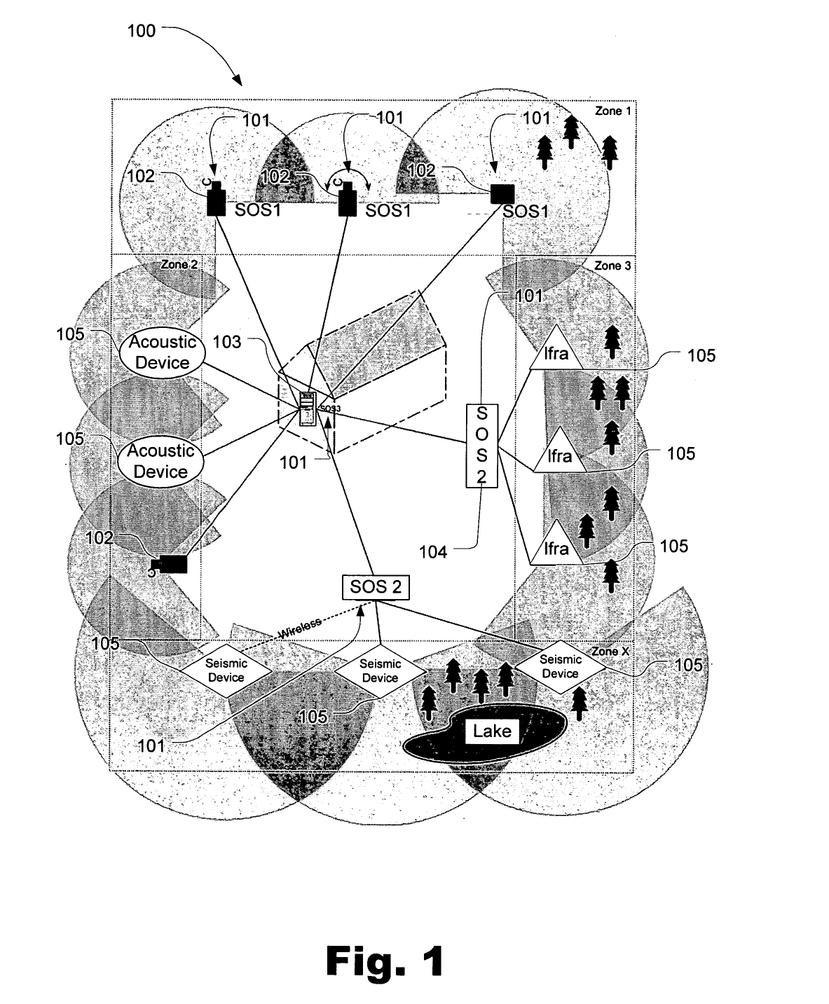

By placing the SOS (101) at the camera (102), as shown in FIG. 1, it provides the ability to program the camera (102) with image processing algorithms, thereby making the camera (102) ‘intelligent.’ With the SOS (101) at the camera (102), video communication still takes place between the camera (102) and the workstation (103) with the addition of smart algorithmic messaging such as motion detection alarms. In addition, the camera (102) can report its operational status, control what and when an image is transmitted, and in turn send compressed video via standard protocols such as wireless 802.11. For wide geographic areas, the SOS (101) may be quickly deployed with Data Repeater Units (DRU) to send data over greater distances. Placing the SOS (101) at the camera (102) provides a scalable architecture (100) where more than one camera (102) can be quickly deployed and controlled by a single workstation (103) with limited or no cabling.

By placing the SOS (101) sensor near a “bank” of cameras (104) deployed to protect a given geographic zone, as shown in FIG. 1, allows a single SOS (101) to monitor multiple cameras. An advantage is that this configuration saves cost in terms of SOS (101) hardware. On the other hand, cabling is limited between the cameras (104) and the SOS (101) and communication bandwidth is limited between the SOS (101) and the central control workstation (103). The key advantage to this configuration is that it enables wide-scale zone protection by increasing the number of cameras (104) that can be controlled from a central control workstation (103).

By placing the SOS (101) at the central control workstation (103), as shown in FIG. 1, centralizes all processing to a single location. This configuration represents a very easy upgrade path for existing surveillance systems, since current surveillance systems have all video and infrared (IR) cameras (102) wired to a central control point.

In one embodiment, placing the video processing functions throughout the camera surveillance network has several distinct benefits by adding video detection algorithms to video and thermal sensors.

Adding video detection algorithms to video and thermal sensors integrates reliable motion detection, tracking, and classification algorithms to existing video and infrared sensors to transform the video sensor into a simple, user-free, surveillance appliance.

A significant advantage to the SOS architecture is that it provides a platform to add “smart” capabilities to optical surveillance cameras that provide continuing improvement to perimeter security. Some of the algorithms that would enhance the SOS camera's ability to evaluate a threat include, but are not limited to; motion detection; target detection; initiate object tracking; temporal frame differencing and object tracking model; added triggered video confirmation to non-video sensors; control integration; sending a ROI; remote operation/remote software downloads; wireless; and scalability.

A key component to making video surveillance effective at intrusion detection is the motion detection algorithm. The lack of effective motion and target detection prevents video sensors to be used as sensors for many security applications. There are three conventional approaches to motion detection which are temporal differencing, background subtraction, and optical flow.

Temporal differencing is very adaptive to dynamic environments, but generally does a poor job of extracting all relevant feature pixels. Background subtraction provides the most complete feature data, but is extremely sensitive to dynamic scene changes due to lighting and extraneous events. Optical flow can be used to detect independently moving targets in the presence of camera motion; however, most optical flow computation methods are very complex and are not applicable to real-time algorithms without special hardware.

This motion detection algorithm described here increases the reliability of detecting movement by utilizing a combination of adaptive background subtraction approach with frame differencing to make background subtraction more robust to environmental dynamics. These algorithms also consider the number, intensity and location of pixels that represent movement in order to determine the relative distance from the sensor relative to the ground. Regular, consistent movement such as that caused by wind blowing through trees can be identified and discarded through pattern analysis and measurement of relative pixel movement throughout the image, providing a robust algorithm for outdoor applications.

Motion detection algorithms are ideal for perimeter security applications where all motion needs to be detected for threat evaluation. Adding zone definition sophistication to motion detection in wide FOV panoramic views allows the user to define varying levels of detection within a continuous 3600 panoramic, logging discrete defined events.

Adding target detection algorithms to the SOS platform will provide the intelligence to the sensor to determine what constitutes an “event” worthy of triggering an alarm. Once motion is detected, image processing techniques can be performed to detect and classify an object to particular target group, therein providing the first level of threat assessment. The target detection algorithms take the blobs generated by motion detection and match them frame-to-frame. Many target tracking systems today are based on Kalman filters, and therefore their performance is limited because they are based on unimodel Gaussian densities and cannot support simultaneous alternative motion hypothesis.

Initiate object tracking is when a region is detected whose “bounding box” does not sufficiently overlap any of the existing objects. This region then becomes a candidate for a true object, however, since this object could also be noise the region is tracked and only if the object can be tracked successfully through several frames, then it is added to the list of objects to be tracked.

When video frames separated by a constant time are compared to find regions that have changed this is the temporal frame differencing and object tracking model. The first step in this process is to take the bounding box generated by motion detection and match them frame-to-frame. A record of each bounding box is kept with the following information:

1. Trajectory (position p(t) and velocity v(t) as function of time) in image coordinates,

2. Associated camera calibration parameters so that the target's trajectory can be normalized to an absolute common coordinate system (\hat{p}(t) and \hat{v}(t)),

3. The “bounding box” data: size s and centroid c, color histogram h.

4. The position and velocity of Tᵢ from the last time step tₗₐₛₜ is used to determine a predicted position for Tᵢ at the current time t_{now}:
\hat{p}ᵢ(t_{now})≈\hat{p}ᵢ(tₗₐₛₜ)+\hat{v}ᵢ(tₗₐₛₜ)×(t_{now}−tₗₐₛₜ).

5. Using this information, a matching cost can be determined between a know target Tᵢ and current moving “box” Rᵢ:
C(Tᵢ,Rᵢ)=f(|\hat{p}ᵢ−\hat{p}ⱼ|,|sᵢ−sⱼ|,|cᵢ−cⱼ|,|hᵢ−hⱼ|)

Matched targets are then maintained over time. An alarm signal can be generated in a pre-defined scenario. For example, if an object is moving towards a restricted area, such an alarm signal increases situational awareness and enables the SOS to automatically determine and report a threat potential.

Added triggered video confirmation and non-video sensors uses other sensors (105), such as seismic, Infrared (IR) beam, acoustic, Radio Detection and Ranging (RADAR), and laser sensors, to act as primary or redundant triggers to the SOS (101).

Control Integration automatically directs pan-tilt-zoom cameras (102), searchlights, or weapons to detected targets.

By only sending the Region of Interest (ROI) of the detected targets reduce bandwidth of video signals.

Remote operation/remote software downloads makes intelligent surveillance easy to support and maintain. Downloading new algorithms such as target detection, tracking, and identification to the SOS is a simple operation which stems from placing the “smarts” at the SOS making decisions regarding motion and target detection at the surveillance system level and alleviating complex communication issues between the cameras (102) and the workstation (103).

Wireless communication between the camera (102) and the control station (103) eliminates coaxial and control cabling. With the SOS (101) near the camera (102), the necessary bandwidth reduction image processing enables medium speed wireless Radio Frequency (RF) links.

Perhaps the most important advantage of the SOS architecture (100) is scalability. The SOS unit (101) provides system integrators with a flexible architecture (100) that distributes the image processing burden to the most sensible locations. This distributed computing paradigm enables the reduction of processing from any single control workstation (103).

Hence, the SOS (101) provides a distributed architecture (100) where multiple cameras can be deployed easily to provide surveillance to a large geographic area with control and monitoring from central or distributed locations. The SOS architecture (100) promises to provide the next generation of cameras (102) that are easy to install and support and provide reliable intrusion surveillance that can be verified through video recording playback. By adding intelligence to the optical sensor, the SOS (101) shifts surveillance into a paradigm of pervasive intelligence where human users are augmented or even replaced.

In order to design an innovative Smart Optical Sensor (SOS) platform, one must clearly define the SOS requirements. The SOS (101) may be conveniently defined along two communication planes; a data plane that encompasses all image processing operations (e.g. motion detection processing) and a control plane that encompasses all non-data transaction (e.g. motion detection reporting). Data plane operations involve high-speed image sensor inputs, a high-speed data processing engine, and a medium speed peripheral component access. The control plane transactions are the logic that determines what algorithms are running and where data is routed. Since the data operates from the core of the SOS video processing engine, to follow is a brief description of the sensors attached to, algorithms running on, and peripherals connected to the SOS.

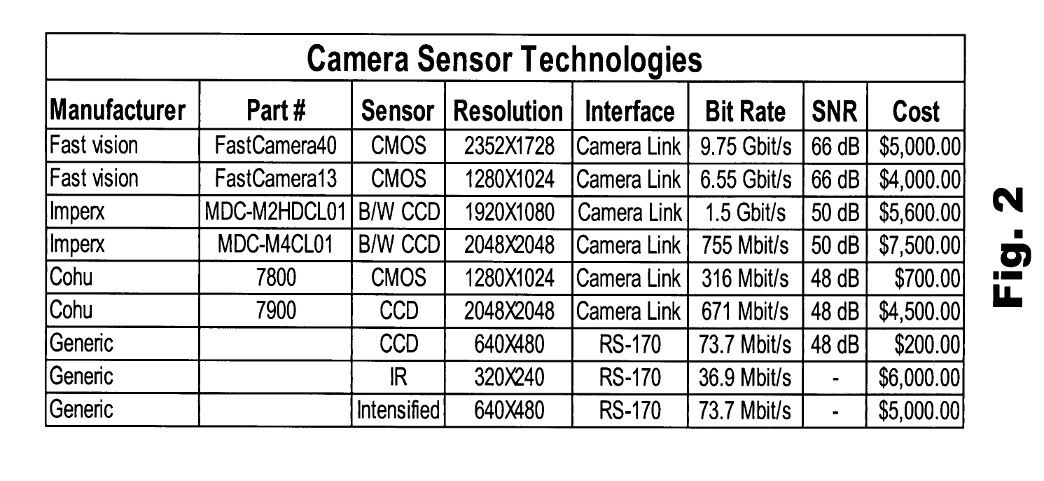

In order to provide an effective solution, the Smart Optical Sensor (SOS) (101) must be able to accept video signals from a variety of cameras, supporting both high-speed sensors and traditional infrared (IR), Intensified Imager (I²), and visible sensors. FIG. 2 contains a brief summary of currently available optical cameras. In addition, different cameras have different physical interfaces. While most current sensors use a composite of NTSC/RS-170 physical connectors, recent mega-pixel Charge Couple Device (CCD) and Complementary Metal-Oxide Semiconductor (CMOS) cameras have adopted CameraLink over LVDS (RS-644).

From FIG. 2 it is clear that next-generation sensors require bandwidths on the order of Giga-bits per second. It is important to note that data acquisition capabilities bind the analysis capabilities of the SOS real-time processing engine. On the other hand, the SOS must also support current NTSC/RS170 technologies to allow maximum ease of integration with existing surveillance systems.

Real-time execution of intelligent surveillance algorithms on the SOS is the key to the success of the platform. While it may be possible to run high-speed video streams through several algorithmic layers on a supercomputer, the SOS must achieve the same performance at a reduced cost, power, and form factor. What is needed is a platform that provides the same benefits while operating much more efficiently. The SOS will provide the video processing algorithms with a computing platform that is an optimized and highly efficient environment. By doing so, it uses multiple layers of video processing simultaneously, to achieve this new paradigm of intelligent surveillance.

A brief description of these possible algorithms is provided below. These algorithms are classified into the following three suites; Image Enhancedment Suite, Video Content Analysis Suite, and Integration and Control Suite.

The Image Enhancement Suite includes SolidVision, Solid Resolution, and Solid Fusion. These algorithms, when implemented on the SOS platform, provide valuable pre-processing features such as stabilization prior to motion detection.

SoldVision is a technique that utilizes the major feature points from an image to perform multi-frame registration to correct cross-frame jitter via an affine transform.

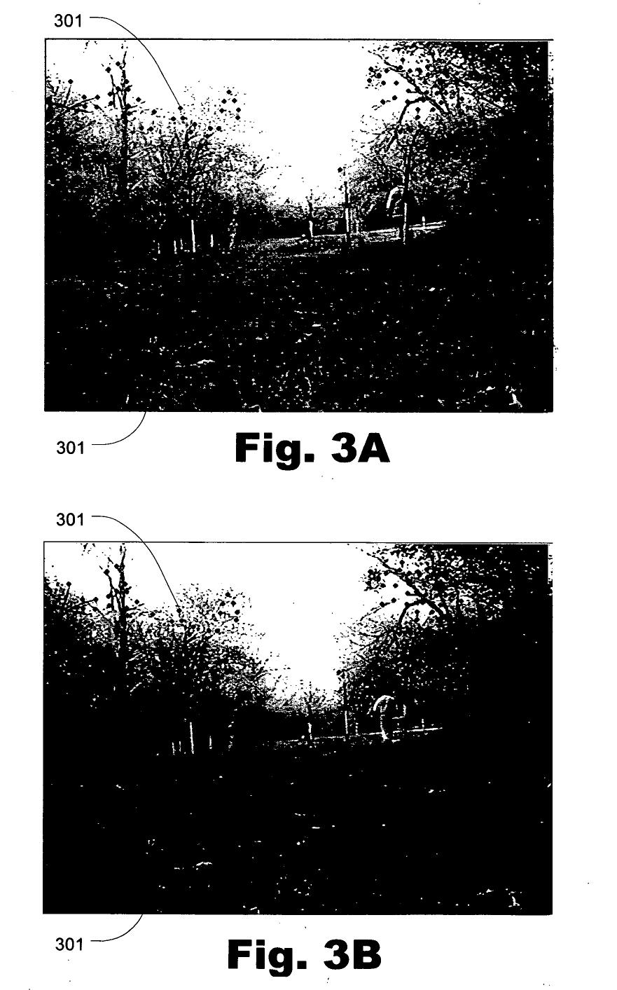

FIGS. 3A and 3B show an example of automatic feature point extraction for inter-frame registration for video stabilization. The feature points (301) are fairly consistent between frames. The affine transformation between different images can be calculated using a least mean square method based on the location of these points (301). Finally, the transformation is applied to each frame, yielding a stable succession of video images.

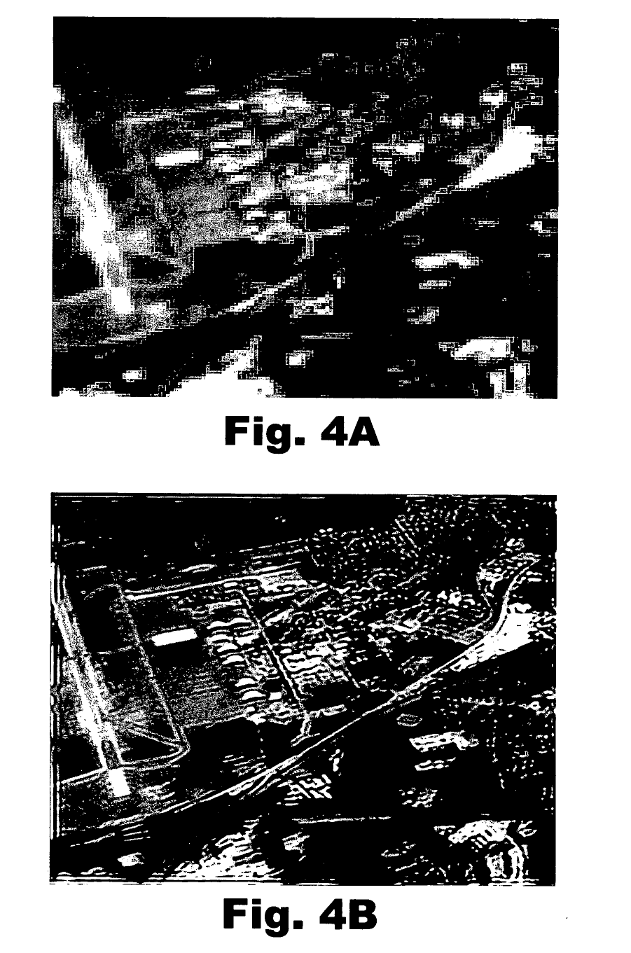

FIGS. 4A and 4B demonstrates the benefits achieved from the SolidResolution algorithm. The SOS is particularly useful for implementing the super-sampling algorithm because it enables high frame rate captures from Complementary Metal-Oxide Semiconductor (CMOS) cameras. FIG. 4A is a picture of a 128×128 single frame photograph. Contrasting this to FIG. 4B which is a 1024×1024 composite of 100 frames obtained via the high frame rate captures from Complementary Metal-Oxide Semiconductor (CMOS) cameras using the super-sampling algorithm.

The image fusion problem can be characterized as the construction of a representation of an object based on the images obtained by multiple sensors that observe the object differently. For example, an infrared (IR) image and a visible image both contain the same object shape information but different object “brightness”. While a visible image may provide fine details during day-light conditions, and an infrared (IR) image provide details during night time. SolidFusion fuses visible with infrared (IR) image which reveals fine details during twilight.

The Video Content Analysis Suite includes SmartDetect, SmartClassify, and SmartTrack. This Suite is computer vision for the SOS. By “seeing” objects, tracking them, and classifying their shape, the SOS achieves an artificial intelligence that forms the core of the SOS paradigm.

A key component to making video surveillance effective at reacting to intrusion is the motion detection algorithm. The lack of effective motion and target detection algorithms is specifically addressed by the SOS.

The SmartDetect algorithm increases the reliability of detecting movement by utilizing a combination of adaptive background subtraction with frame differencing to make background subtraction more robust to environmental dynamics. These algorithms also consider the number, intensity and location of pixels that represent movement, in order to determine the relative distance from the sensor to the detected object. Regular, consistent movement such as that caused by wind blowing through trees can be identified and discarded through pattern analysis and measurement of relative pixel movement. Thus a robust algorithm for outdoor applications is provided.

Once motion is detected, image processing techniques can be performed to detect and classify an object to particular target group, providing the first level of threat assessment. Adding SmartClassify target detection algorithms to the SOS platform provides the intelligence to determine what constitutes an “event” worthy of triggering an alarm. The first step in this process is to take the blobs generated by motion detection and matching them frame-by-frame. Many target tracking systems are based on Kalman filters, and their performance is limited because they are based on Gaussian densities and cannot support simultaneous alternative motion hypothesis. The SmartClassify algorithm utilizes a unique method of object tracking for real-time video based on the combination of a frame differencing motion detection technique and trajectory modeling.

SmartTrack is a combination of detection and classification algorithms to track multiple objects even when they cross paths. This algorithm can be used in combination with the target selection and integration and control algorithms to track user-specified targets in a crowd of other detected targets.

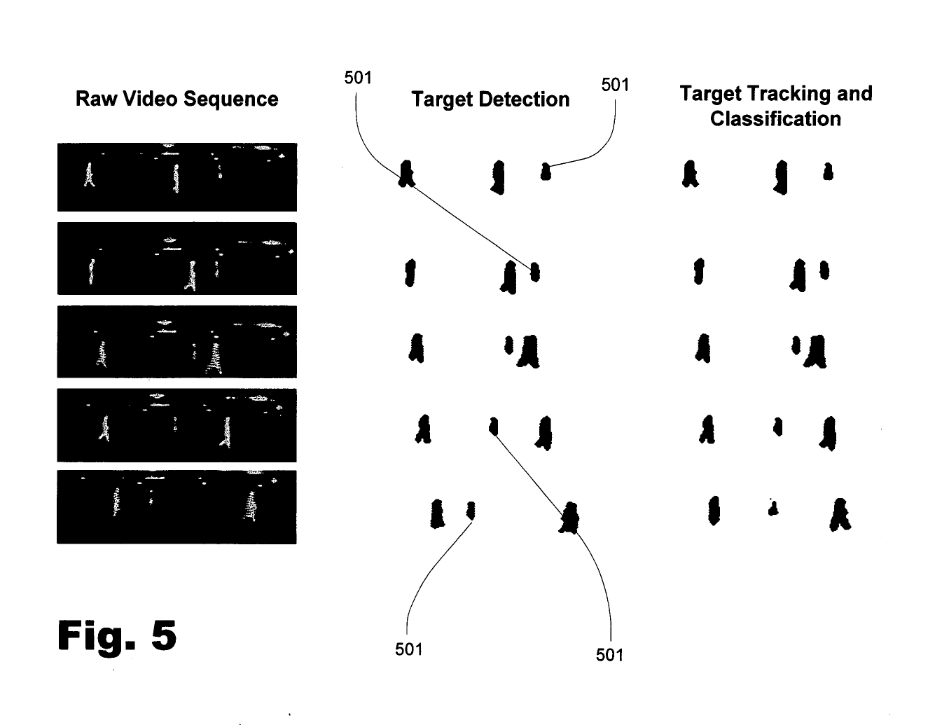

FIG. 5 demonstrates frame progression with multiple target tracking. A single object (501) can be tracked through a field of multiple targets even when that object (501) has crossed the path of multiple targets already being tracked.

The Integrateion and Control Suite includes BandwidthControl, ZoneControl, TerrainControl, and ResponseControl. In order to achieve the full benefits attainable from the SOS platform, a high-level protocol must be established between the SOS and the integration application. The Integration and Control Suite defines this protocol, allowing maximum benefit from the SOS algorithms while reducing the bandwidth required to transmit vital information. It is also important to note that the integration and control functions are control plane centric, with the obvious exception of encryption and compression.

The BandwidthControl reduces the bandwidth between the SOS and the user application, lossy compression, non-lossy compression, or region of interest (ROI) coding algorithms will be available on the SOS. To increase security, a standard encryption algorithm could be implemented at the SOS as well.

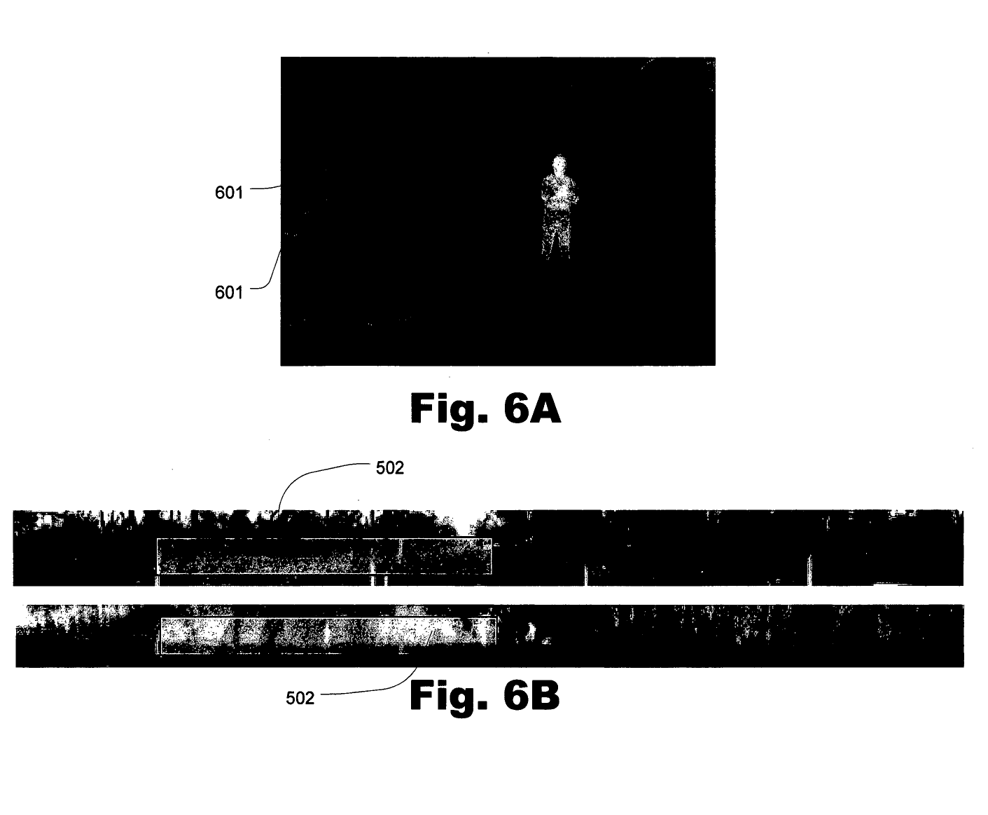

A user application may define a detection zone and detection behavior to the SOS. When motion is detected in the particular zone, the SOS generates an alarm message. ZoneControl's algorithmic behavior is designed specifically for the purpose of reducing bandwidth between the SOS and the central control station. Instead of blindly sending an alarm with a video stream of the alarm scenario, the SOS first makes a smart decision. FIG. 6A illustrates a directional dual alarm trip wire (601) algorithm. The trip wires (601) generate different alarms, and they may be programmed on a directional basis. FIG. 6B demonstrates a specified ‘ignore’ zone (602), such as a legitimate high activity zone.

TerrainControl is used when the SOS is equipped with a Global Positioning System (GPS) receiver and an electronic compass, the SOS will then send all the information necessary to map detected objects on a Geospatial Information System (GIS). By mapping objects on a Geospatial Information System (GIS), a complete 3D view of the surveillance area can be easily generated.

Using ResponseControl's algorithmic feature with its abundance of peripheral interfaces, the SOS may be programmed to control a Pan-Tilt-Zoom (PTZ) camera, a weapon such as an automatic machine gun, or a motorized search light.

The algorithmic requirements from the SOS are very extensive, especially since there is a concrete requirement for “running” the algorithms in real time. Assuming that such performance is achievable, we shall now continue to define the required interfaces between the SOS and the outside world.

In order to provide seamless integration of the SOS to existing surveillance systems, common sensor and video peripheral interfaces should be built into the platform. On the other hand, in order to provide the most advanced features and capabilities, the Smart Optical Sensor (SOS) could support, or have the modular capabilities to support, advanced peripheral features such as USB 2.0. Separating the required interfaces from modular future interfaces we have:

Required Interfaces
10/100 Ethernet
NTSC/RS-170 Composite Output
RS232
Real-time Parallel Output Control Signals (5V/12V/24V)
LCD/CRT Display Driver
PCI Bus

Modular Interfaces
802.11b End Point Interface
USB 2.0 End Point Device
Additional Serial Ports (RS2321422/485)
Global Positioning System (GPS)
Electronic Compass
Electronic Gyro

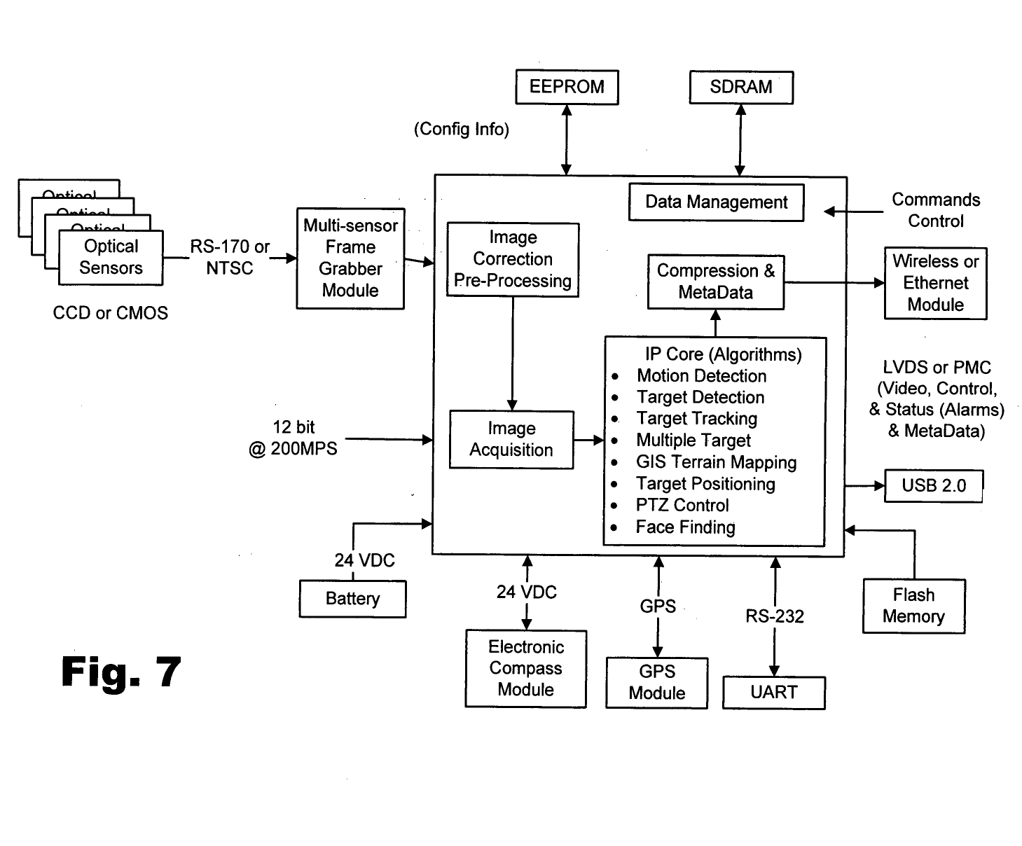

FIG. 7 is a functional block diagram of the SOS. Examining all of the technological complexities arising when designing the SOS appliance, it is clear that easily deployable surveillance solutions require an innovation in surveillance computing. On the one hand advances in Complementary Metal-Oxide Semiconductor (CMOS) image sensor technologies have yielded video streams on the order of 10 Giga-bits per second (FIG. 2, FastVision FastCamera40). On the other hand, easily deployable wireless networks yield a very limited video bandwidth that is on a practical order of 1 to 6 Mega-bits per second. In addition, advances in video processing algorithms require very powerful processing engines, especially in order to utilize the information provided by Mega-Pixel video cameras.

The SOS parallel processing platform addresses all of the above contentions in an innovative way that empowers security systems with the tools to use today and tomorrow's leading-edge surveillance technologies. In essence, the SOS leaps beyond the Moore's-law limited processing capabilities of standard surveillance systems to catch up with the Shannon information growth that computer vision algorithms have exhibited in the past few years. Hence, the SOS offers the following solutions; connectivity to mega-pixel cameras at rates as high as 10 Giga-bits per second; a flexible, yet very powerful, video processing architecture; low-power, embedded, at-the-camera operation (less than 10 watts); real-time video processing of the three algorithm suites; and connectivity to a wide range of surveillance peripheral devices and networks.

In short, the SOS is a small, low-power, video processing engine that has the capability of accepting high-speed video streams, processing the streams with algorithms such as motion detection, generating alarms, and sending compressed video over a medium speed network (e.g. a wireless link).

In order to provide a readily available development environment, all commercially available video processing engines are either Peripheral Component Interconnect (PCI) or Peripheral Component Interconnect extended (PCI-X) Personal Computer (PC) based. All of these Personal Computer (PC) systems are expensive and power-hungry (50 to 200 Watt operation). In addition, in order to gain a maximum advantage from processing engines such as Matrox's and Cognex's, the algorithm developer has to learn a specialized programming language that is hardware specific.

The SOS architecture is unique in the sense that it capitalizes on very recent advances in Broadband Signal Processor technologies in conjunction with advances in Field Programmable Gate Array (FPGA) technologies. The development of an innovative low power, high end video processing engine that is tailored to the algorithms suites is the SOS paradigm. Yet, the implementation of such a novel video processing architecture has its risks.

In order to mitigate the risks stemming from the development of such a powerful video processing engine, the SOS design calls for a unique signal processing approach. On one hand, many of the algorithms exhibit inherent parallelism. On the other hand, all of the algorithms depend on the flow of video frames, suggesting cumulative results from serial signal processing.

One option, is to execute a few algorithms from the same suite in parallel to each other. In other words, a digital signal processor (DSP) or a Broadband Signal Processor (BSP) is called for, yet, a low-power DSP or BSP which is capable of processing a constant Giga-bit per second stream with all of the above algorithms does not exist.

That is why the SOS takes the novel approach of parallel pre-processing using a field programmable gate array (FPGA). By using the parallel features of a FPGA, such as configurable high-speed parallel multiply units, many of the pre-processing algorithms can be performed prior to using the BSP. Moreover, FPGA have become so large that entire processor cores can now be loaded directly onto the programmable chip. Nonetheless, FPGA are still quite expensive, and while a million gate FPGA costs about $400, a BSP with 13 million transistors costs less than $100. BSP also have the advantage of on-chip integrated peripherals that enable immediate high-speed connectivity. Furthermore, BSP are integrated circuits specifically designed for video processing. With Very Long Instruction Words (VLIW), and advanced predictive cache and branch prediction, BSP are capable of true single-cycle matrix operations. Such BSP instructions are known as single instruction multiple data (SIMD) fetch instructions.

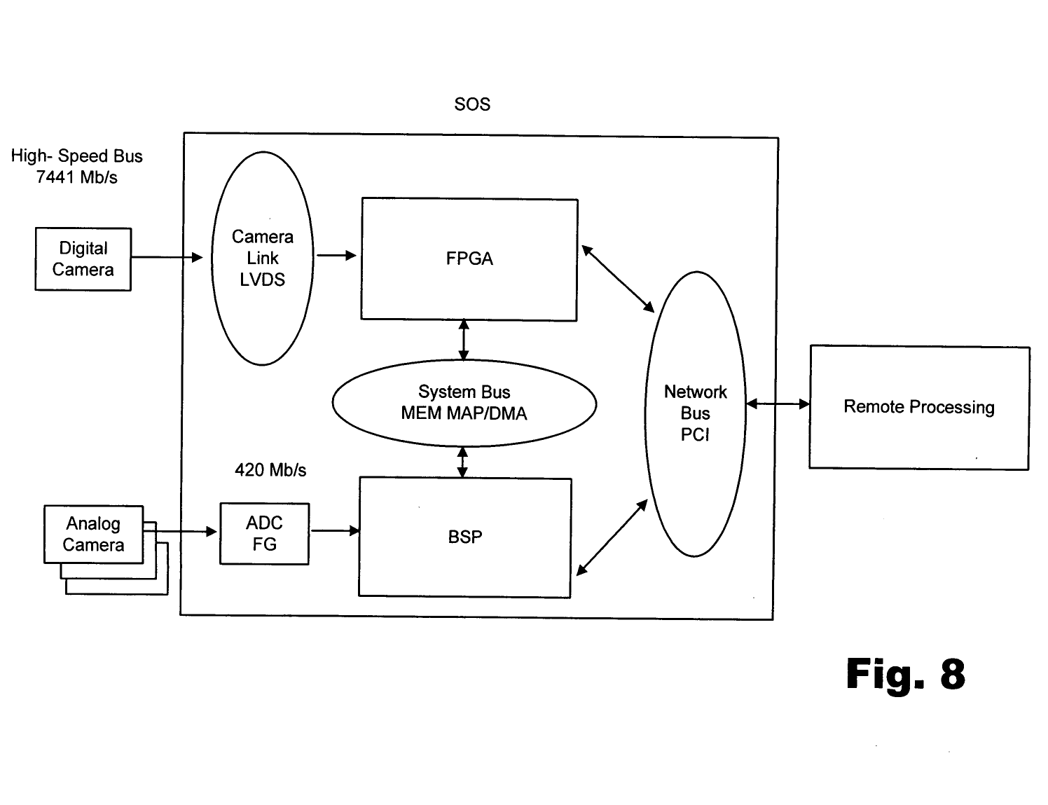

The true flexibility of the dual FPGA-BSP architecture comes to life when large data transactions are considered. For example, while the FPGA is an excellent pre-processing engine, it is also capable of providing the BSP with additional fast-speed intermediate computations. When the BSP program requires single cycle multiple capabilities, it may simply off-load the task to the FPGA to run in parallel with current code execution. Moreover, by memory mapping the FPGA using a Direct Memory Access (DMA) controller, one can achieve both high speed operation (64 bits/sec @ 133 Mhz), and zero cache misses on the BSP, because the FPGA independently accesses memory. FIG. 8 shows the novelty and innovation of utilizing the parallelism and flexibility advantages of a FPGA with the low cost and connectivity advantages of a BSP, in the SOS architecture.

Historically, embedding software in real-time has been a significant challenge. However, recent advances in both hardware and software development tools have greatly enhanced the speed of embedded algorithm development.

The following describes the technical approach to real-time software development. To illustrate the advantage of the approach it is suggested that one start with a description of the standard embedded algorithm development process.

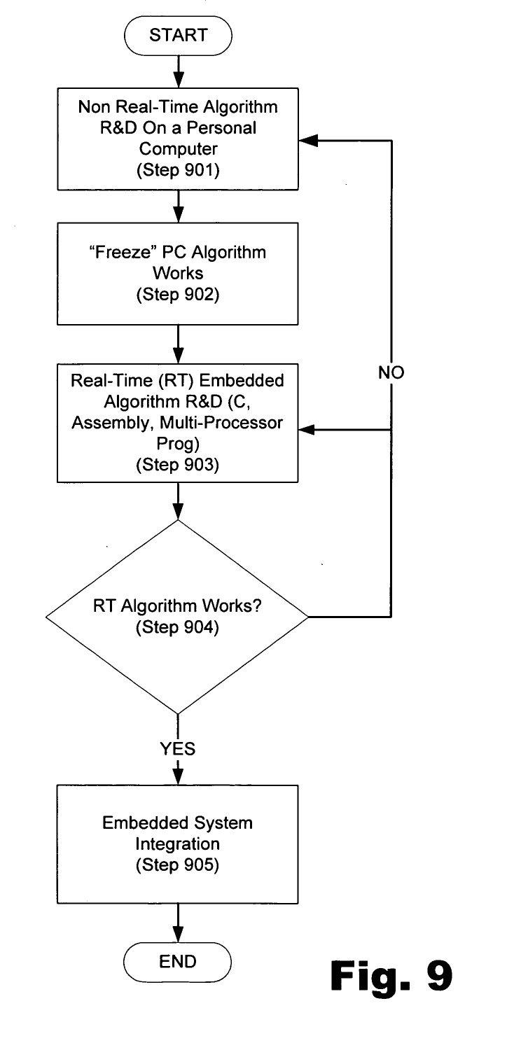

Real-time algorithm development usually progresses in six critical steps, as described in FIG. 9.

Non Real-Time Algorithm R & D on a PC (Step 901), this step is a “proof of concept”, where the algorithm is prototyped and proven to work. In this phase of algorithm development, ease of programming, and the flexibility of using a PC are invaluable as algorithm researchers and developers develop the mathematical models that make a new algorithm.

“Freeze” PC, Algorithm Works (Step 902), at this point development on a PC or Workstation is frozen since embedded real-time development has to “catch-up” to the current state of the algorithm. This means that the main algorithm developers must “sit idle”, and stop development for a while.

Real-Time (RT) Embedded Algorithm R & D (C, Assembly, Multi-Processor Programming) (Step 903), this is a true research and development effort since real-time implementation of algorithms is a science in itself. During this phase of the effort the algorithm is structured according to functional blocks, where each block is examined for computational intensity, memory usage, parallel vs. sequential operations, floating point operations, and data streaming rates between functional blocks. During this step of development the algorithm is also placed into a real-time operating system framework where all real-time operations are considered. These operations include signal acquisition and display, as well as control-plane processing.

The huge delay in development associated with this step is typically due to the complexity involved with the real-time framework, and the need to tailor the algorithm to the available processing resources. Moreover, it is often the case that the algorithm must be executed using a few processors, and ASICs or FPGAs in order to fulfill the real-time requirement. Such design always entails an expensive system integration effort as co-processor communication protocols must be refined to eliminate bus access latencies.

Real-Time Algorithm Works? (Step 904), this milestone is usually reached when the embedded effort is unsuccessful, or when the system is ready for embedded integration. If real-time performance cannot be achieved, the options are to either add processing hardware, or to revisit the core algorithm on the PC to see where it may be optimized. Both options are very expensive, but this process usually requires at least two iterations before a complex algorithm is placed into a real-time system.

It is important to realize that having a working real-time algorithm does not necessarily mean that the system is ready to perform its task. It is often the case that at the end of this step one has proven that the embedded platform has plenty of resources to run the algorithm, and hence algorithm execution should be successful in real-time.

Embedded System Integration (Step 905), the final, most critical, and usually most time-consuming step of development is system integration. Even though real-time algorithm operation has been proven, running the system with all of the necessary control-plane functionality requires a lot of work before a fully functional real-time platform is achieved. For example, one may prove that an algorithm requires only 25% of the overall processor time, and that control-plane functions require only 5% of the overall processor time. Further, lets assume that some portion of the algorithm, and all of the control-plane functions occur on processor 1 (5%+5% of the processing), and the critical algorithm segment occurs on processor 2 (20% of the processing). In this case, the integration task is to ensure that all threads running on processor 1 can execute in a timed fashion, and that data flow between the two processors is not hindered by the shared bus.

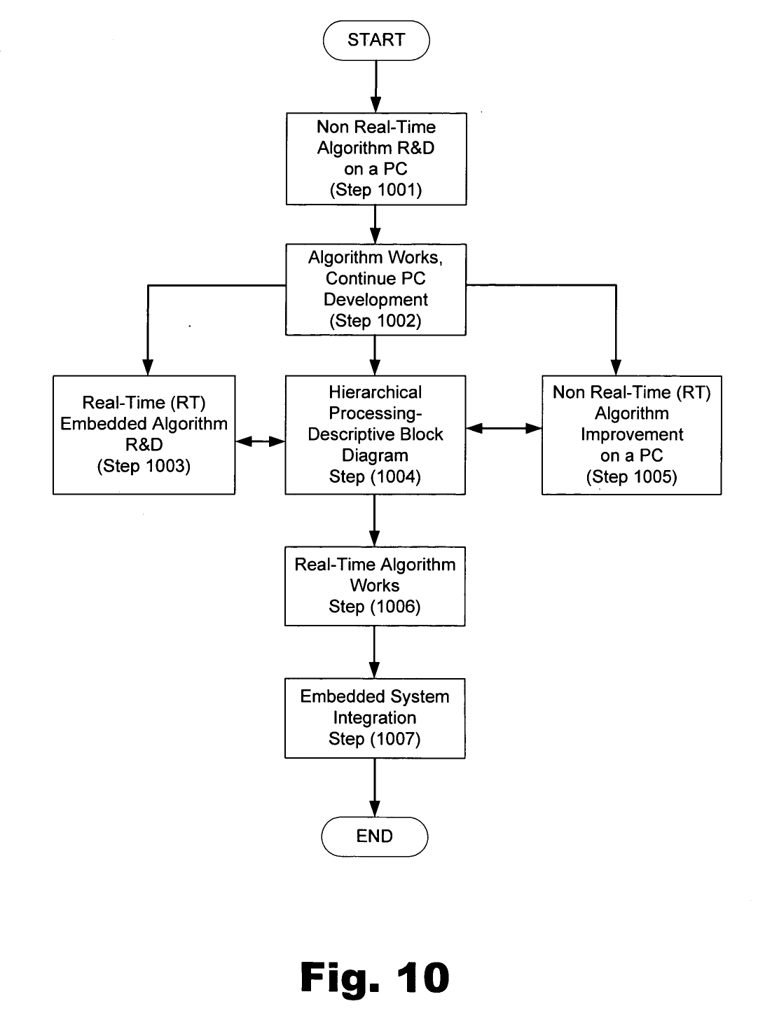

The solution to embedded algorithm development, as detailed in FIG. 10, is quite unique. In short, one can alleviate the complexities caused by the “random” bus operations by using the proprietary RAPID-Vbus architecture.

Non Real-Time Algorithm R & D On A PC (Step 1001), this step is similar to the traditional method of real-time algorithm development, and quickly proves that the algorithm works. The major task in this step is functional flow-charting of the algorithm. This task is conducted in parallel to the development effort itself, and in general it helps facilitate good coding and debugging practices.

Algorithm Works, Continue PC Development (Step 1002), at this point one should reference the working algorithm using a source control system (such as MS Visual Source Safe), and proceed to Steps 1003-1005. In Steps 1003-1005 the algorithm developers continue improving the algorithm on the PC platform, while working with the embedded developers.

Real-Time (RT) Embedded Algorithm R & D (Step 1003), this step differs significantly from the traditional embedded development approach. Here the algorithm developers and the embedded developers are working side by side from the moment the algorithm was proven to work (Step 1002). The communication between the algorithm developers is via a structured document, the Hierarchical Processing-Descriptive Block Diagram.

Hierarchical Processing-Descriptive Block Diagram (Step 1004), this diagram, along with its documentation, enables the rapid development of real-time algorithms. By structuring each algorithm using the diagram, golden vectors are easily established using the PC algorithm, and the embedded performance is reliably tested for each diagram block.

Non Real-Time Algorithm Improvement On A PC (Step 1005), while the algorithm is embedded, the algorithm developers help with the optimization tasks, such as floating point to fixed point conversions, and alternate processing methods. In addition, algorithm developers continue the overall algorithm development, and as long as the Hierarchical Processing-Descriptive Block Diagram (Step 1004) is updated, the embedded developers leap ahead with better overall solutions.

Real-Time Algorithm Works (Step 1006), when the algorithm has been proven to work on the embedded platform, and real-time performance is achieved, the system is ready for the final integration. It is important to note that this approach completely parallelizes all embedded algorithm development Functions. The result is the most effective use of a critical and expensive resource: Algorithm Developers. Moreover, this approach eliminates the need for numerous iterative sequential development cycles with a single well-focused and concentrated effort.

Embedded System Integration (Step 1007), the embedded SOS system, empowered by the RAPID-Vbus architecture, is designed in a way that enables the real-time use of multi-processor computing resources without any final integration efforts. In other words, during the algorithm development stage (Steps 1003-1005) one can section the hierarchical algorithm blocks according to optimal processor usage. Algorithms are targeted for 3 platforms, a Single Instruction Multiple Data (SIMD) DSP, in which algorithm sections containing sequential vector/matrix operations are executed at Giga-Op-Per-Second speeds using a high speed DSP (600 MHz to 1 GHz); a parallel processor FPGA, in which algorithm sections containing massive parallel operations, such as pixel scaling, or binning, are executed using single clock cycles at medium speeds (440 Multiplies Per Clock)×(330 MHz)=145.2 Giga-Multiplies-Per-Second; and a Reduced Instruction Set Computer (RISC), in which algorithm sections that require sequential scalar operations are executed using a high-speed low-power Reduced Instruction Set Computer (RISC) processor (600 MHz to 1 GHz).

This development approach is based upon the RAPID-Vbus architecture that provides the best possible algorithm development environment. Reduced Instruction Set Computer (RISC) processors are serial processors best suited for logically deep scalar operations. Digital Signal Processors (DSPs) are ideal for sequential, iterative matrix processing operations. Field Programmable Gate Arrays (FPGAs) are ideal for massive bit-wide parallel processing. Thus one can provide all three high-speed processing elements in one small, general purpose, low-power processing platform; the SOS. Using the SOS algorithm development is not limited to one type of processing, but each algorithm construct is embedded intelligently, promoting better algorithm development, and better real-time performance. By incorporating all three processing architectures into the SOS, and by designing our algorithms to use all three processing platforms, one can achieve Giga-op performance, at a very rapid development pace. Most importantly, this approach allows one to program all processors, including the FPGA, through simple use of the compilers provided with the processor, using only the C language. Naturally, the drawback to such hardware dependent algorithm partitioning is the final integration and real-time communication between the three hardware processors. But this is exactly where the presented system design prevails. Once the algorithms are partitioned among the above three processors, there is no final integration thanks to the RAPID-Vbus architecture. By designing the processing system around the RAPID-Vbus, one can completely eliminate the multi-processor phase of integration. Such innovative design is not only cutting a very long and arduous development effort short, but it also provides a reliable and streamlined method for synthesizing and fabricating an Application Specific Integrated Circuit (ASIC). Because of the RAPID-Vbus design, one can synthesize the whole algorithm hardware description directly to a fabrication of an ASIC. This RAPID-Vbus architecture and the description of the hardware design are detailed below.

As detailed in FIG. 10, Steps 1003-1005 of the embedded algorithm development is the critical step in the development effort. At the heart of this step is the Hierarchical Processing-Descriptive Block Diagram (HP-DBD) (Step 1004). In order to understand this critical algorithm design and implementation process lets consider an example application. Assume one would like the Small Tactical Ubiquitous Detection Sensors (STUDS) Recorder to do the following: grab images from a camera, stabilize the images using SolidVision, save the stabilized image onto a USB 2.0 mass storage device, detect and track motion within the stabilized image using SmartDetect, and save the motion tracking results onto a USB 2.0 mass storage device.

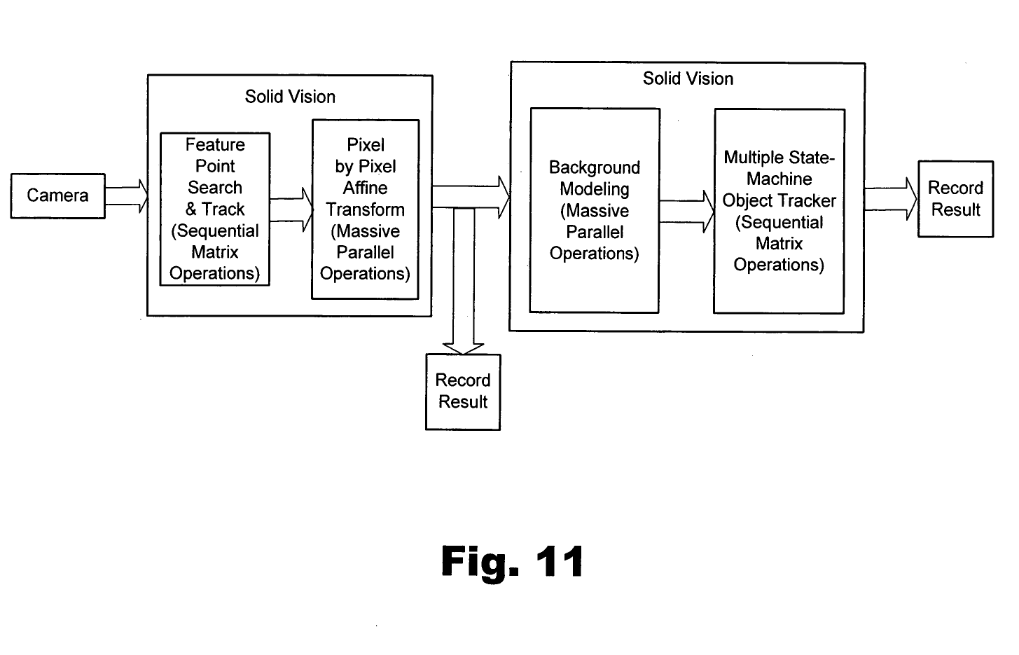

FIG. 11 demonstrates a top-level view of the Hierarchical Processing-Descriptive Block Diagram (HP-DBD) diagram associated with the algorithms to be ported onto the Smart Optical Sensor (SOS). As can be observed, we have a clearly defined processing chain, where each algorithm has been partitioned into two blocks, based on the inherent computational characteristics of the block. Although this is a simplified diagram, it already contains all of the information necessary to turn this diagram into a Smart Optical Sensor (SOS) based real-time system.

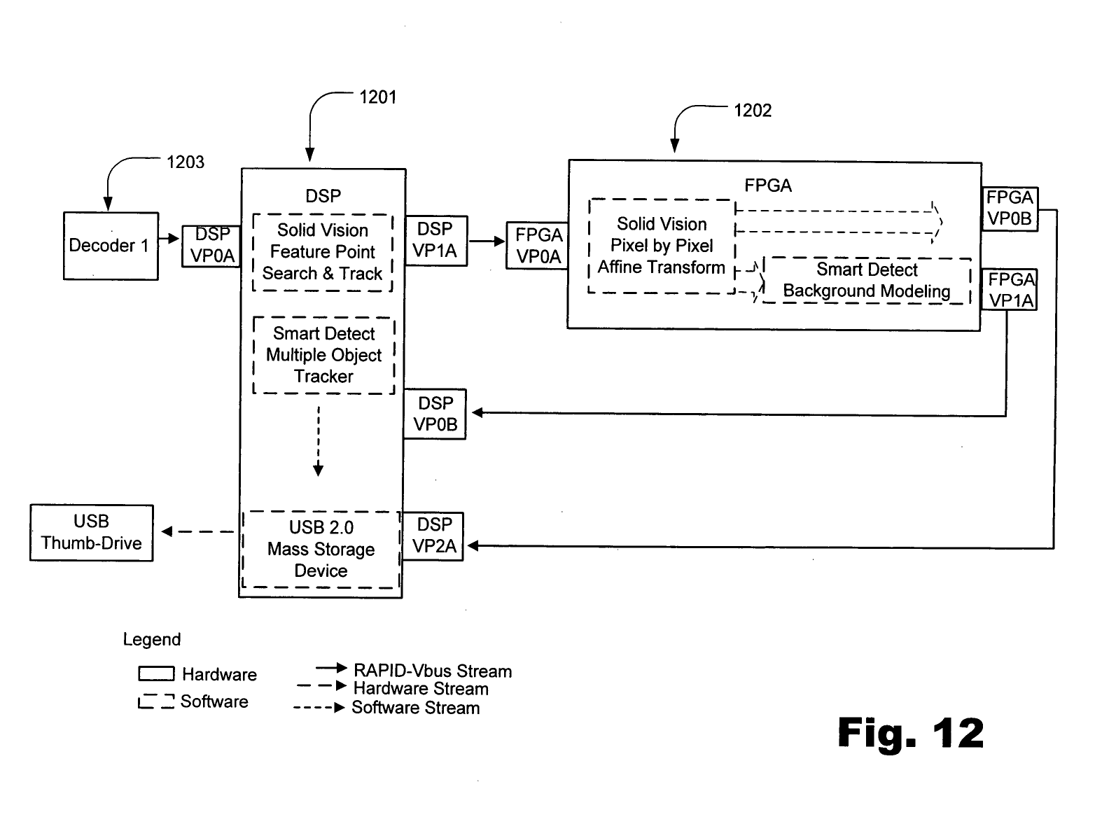

FIG. 12 demonstrates the implementation of these algorithms on the SOS, using the RAPID-Vbus. Note that the sequential matrix operations are running on parallel threads on the DSP (1201), while the parallel operations are running on the FPGA (1202). The RAPID-Vbus enables the hardware streaming of data between the DSP (1201), FPGA/RISC (1202), and Video I/O (1203).

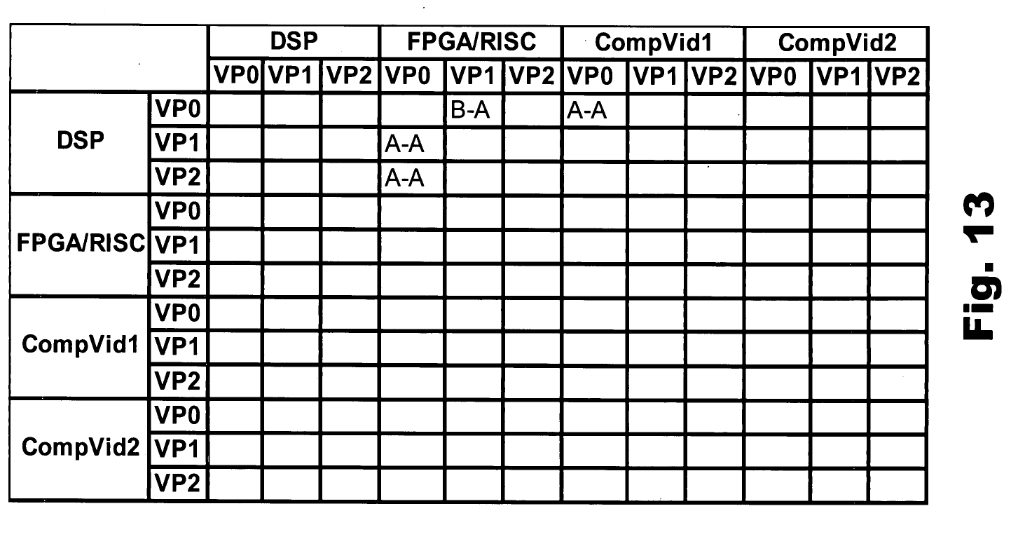

The RAPID-Vbus provides the flexible real-time matrix inter-connects described in FIG. 13. As can be observed, each card (board) of the SOS has three video ports. These ports may be used for video and audio. In our particular example the ports are used to stream video only. Note that each port has two halves, “A” and “B”, and that “B-A” means connect the “B” port from the row on the left to the “A” port from the column on top. The advantage of this design is that the video port interconnect is a hardware function that is completely controlled by software. Thus, algorithms are easily configured and reconfigured as often as the development process requires, while making the final co-processor integration effort as simple as filling the above chart.

In addition, embedding algorithms onto each of our three processor platforms is fast and easy, thanks to advanced use of available tools. All control plane operation, such as time-stamping video frames, and recording onto a USB 2.0 device are conducted on the DSP using TI's DSP/BIOS real-time OS kernel. By taking this approach, one not only has a free real-time micro-kernel, but one will also develop all of our drivers, and DSP algorithms using a single Integrated Development Environement (IDE) (TI's Code Composer Studio). Moreover, since the present system and method has a FPGA with a RISC processor available on the SOS platform, one never has to optimize DSP code using assembly. All SOS programming is done using the C language.

Even programming the FPGA and RISC processor is done using a flavor of the C language, called Handel-C. The IDE one uses for programming the FPGA and its hard-core IBM Power PC 405 processor is Celoxica's Handel-C IDE. As a result all SOS programming is done using C, with the use of two IDEs. All co-processor communication is handled by the RAPID-Vbus, leading to zero final co-processor integration time.

A key to providing networked video surveillance solutions is to place the intelligence at the sensor while keeping the platform small enough and low-power enough to be deployed anywhere. Processing bandwidth versus power consumption and size are the main competing requirements that represent a challenge to all surveillance sensors, and especially to wide-bandwidth video surveillance sensors. While conventional solutions to video processing require power-hungry high-speed processors, the present system and method has a small (2″×2″×3.5″), low-power, but computationally powerful processing engine that is capable of processing high-resolution video streams. The general purpose SOS provides all of the performance expected from high-speed processing boards on a small, embedded, low-power platform. Such performance is achieved thanks to advances in DSPs, FPGAs, RISC, and the RAPID-Vbus.

The SOS offers the following solutions. A flexible, yet powerful, general purpose processing architecture that is distributed and scaleable. Connectivity to mega-pixel cameras at rates as high as 10 Giga-bits per second (Future Option). Low-power, embedded, at-the-sensor operation. Real-time video processing of the three algorithm suites. Connectivity to a wide range of peripheral devices and networks.

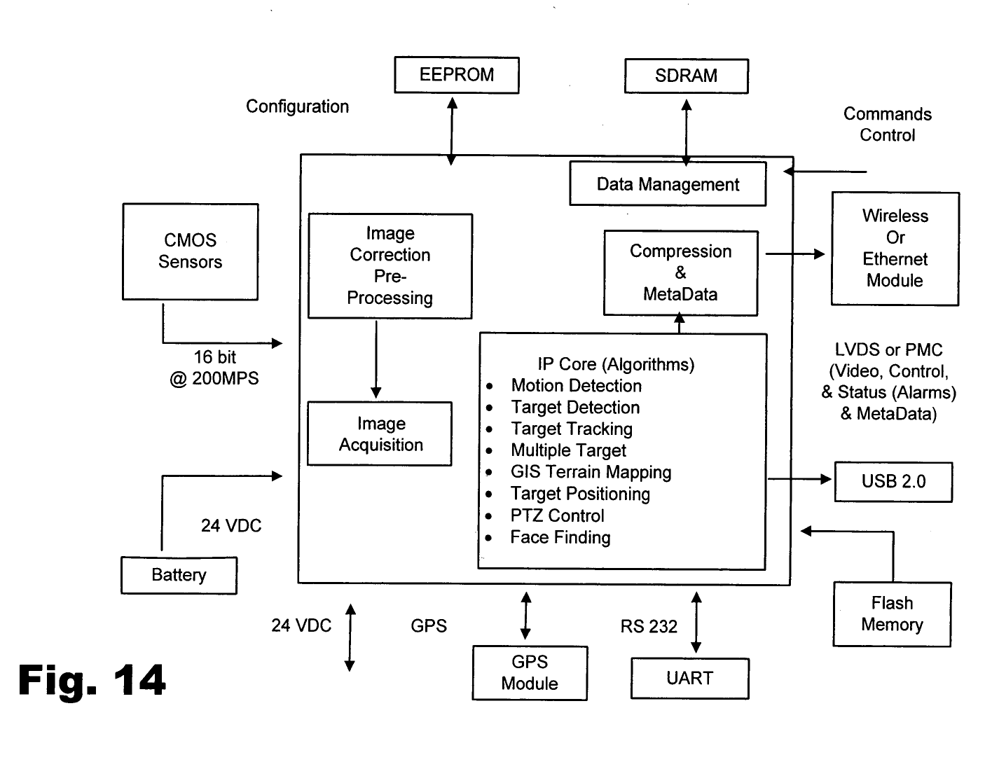

FIG. 14 describes the functions of the SOS. Utilizing emerging high-speed processing technologies, the present system and method has a general purpose processing system operating at high frame rates with 1-5W power, low cost, and within a small, compact form factor. Video sensors (Visible, IR, LADAR, MMW, etc.) provide high-speed digital or NTSC analog video streams directly to the SOS, where image processing is performed utilizing IP cores. Likewise, other sensor modalities, such as acoustic, seismic, bio/chem, and olfactory can be easily integrated with the SOS for signal processing via several high-speed interfaces. The entire assembly is powered using batteries for remote operation or AC adapters for traditional continuous deployment. The SOS communicates metadata via Ethernet, USB 2.0, RS232, and RS485.

The SOS can directly control the sensors and provide synchronization, shutter speed, and other control functions. The SOS can also be integrated with a high-resolution Pan-Tilt-Zoom (PTZ) sensor that tracks detected targets.

The SOS architecture leverages the state-of-the-art DSP, FPGA, and RISC processor technologies in a unique hardware design that utilizes the patent-pending RAPID-Vbus. The RAPID-Vbus provides the innovation of moving wide bandwidth data between processing elements with no latency. This remarkable achievement enables the SOS to provide a flexible, modular hardware and software platform where IP (intellectual property) cores can be developed directly on the real-time sensor processing platform.

With a host of general purpose interfaces the SOS supports the following connectivity; 6 composite video inputs (NTSC, RS170, PAL, SECAM); 2 HDTV outputs; 4 USB 2.0 Ports (480 Mbps Each); 10/100 Ethernet (100 Mbps); RS232 (115 Kbps); RS485 (6 Mbps); and 8 GPIO.

These interfaces easily enable the following; GPS connectivity; Electronic Compass Connectivity; wireless network operation; IP network operation; full frame rate video camera connectivity and control; PTZ camera connectivity and control; and LCD and video display connectivity and control.

Disposable Small Tactical Ubiquitous Detection Sensors (D-STUDS) are able to provide visible/near infra-red video surveillance and target detection/tracking capabilities with a compact package size and ad-hoc wireless mesh network communication channels to form a distributed sensor network. Although other modes may be developed, the primary operational purpose of D-STUDS is to facilitate the ‘holding’ of cleared urban buildings through minimal use of ground forces. Hence, in order for D-STUDS to be operationally usable, “the sensor must provide reliable image detection of anyone entering a perimeter zone that could pose as a threat to friendly forces.”

The primary components of the D-STUDS are as follows; reliable detection algorithm; image sensor; senor optics; NIR illuminator with day/night sensor; image & algorithm processor; communication module; battery; enclosure; and quick mounting solutions.

Please note that although most components specify a part number, the overall architecture does not depend on a particular chip technology. For example, if a better DSP becomes available then it will be used as the main processor instead of the DM640. Similarly, if a new NIR CMOS image sensor manufacturer emerges as better than Altasens, then their chip will be integrated into D-STUDS.

The architecture design approach is based upon the successful development of the SOS, a general-purpose image processing platform. The SOS provides an extremely modular real-time portable architecture with numerous interfaces to integrate peripheral devices. One can utilize the flexibility and modularity of the SOS to provide a portable, 30 fps (frames per second) smart recorder, dubbed the STUDS Recorder. The STUDS recorder is an algorithm development environment, and an optimization platform in a portable form factor that enables the full evaluation of the most critical components of D-STUDS, the detection algorithm.

After a specific location is captured and ‘cleared’ of hostiles, the difficult job of holding the captured area begins. Typically, more forces are needed to protect the rear as friendly forces advance. The function of terrain holding is known to be both dangerous and costly since ground troops are spread over vast geographical areas. What is needed is an inexpensive method to extend the eyes and ears of the war fighter to protect a perimeter through reliable intrusion detection. The detection devices must be deployable within seconds to provide reliable perimeter protection for all day, night, and weather situations. The image sensors must perform during both urban assault “building takedowns” (indoor and outdoor surveillance), and “cave assaults” (total darkness). Thus, the D-STUDS must be mountable on any surface, including dusty walls and wet caves, while it provides the ultimate trip-wire functionality, ranging from a silent alarm to the reliable triggering of defense mechanisms.

D-STUDS may be deployed to specific locations, such as any potential entryway or exit, for ‘holding’ the terrain, while minimizing the deployment of ground forces. They will also be used to form perimeter surveillance around a building to fill-in blind spots, and function as tripwire reactionary alarms.

Disposable sensors are envisioned to be utilized during two tactical operations; clearing a building or an area, and holding a building or an area. The task of clearing and holding the terrain will be facilitated by a series of soldier deployable, small, low-cost, low-power disposable sensors.

Acoustic and imagery sensors are useful in tandem acting as the “eyes and ears”. The acoustic sensors can provide simple detection of movement and its relative location, while image sensors are desired because they provide much richer information, such as a visual confirmation of the target.

The following is the D-STUDS concept of operation. Activation, by one pulling a non-conductive plastic sheet from the D-STUDS, closes the battery circuit and the sensor “boots-up”, waiting for wireless communication. Identification of each sensor provides a unique Identification (ID) during deployment through the wireless interface. Mounting the sensors that are deployed via “sticky” material; the sensors must be deployable or “dropped” quickly. Load position location or drop in number sequence, upon deployment; each sensor is provided a GPS position and compass bearing through the wireless interface. Position location information from the sensor is critical for a soldier to know instantly how and where to react. Position location verification, ensures the PDA “sees” the D-STUDS. BIT and calibration, upon mounting completion the D-STUDS automatically calibrates to the environment, creating what can be termed a background model. The D-STUDS must automatically identify random motion caused by wind, rain, snow, trees, flags, etc. in order to prevent false alarms; furthermore, the D-STUDS will automatically sense the lighting conditions and adjust accordingly. The D-STUDS automatically performs a Build-In Test (BIT) upon request only.

The D-STUDS can be set for the following different type of sleep modes. Full operation mode, in which any motion present within the field of view causes a detection alarm and a compressed image stored locally on the D-STUDS. Soft sleep mode, in which the D-STUDS is “awakened” by acoustic sensors (or any other “approved” sensors) via a wireless interface. Hard sleep mode, in which the D-STUDS is “awakened” by other sensors via a physical interface (TTL).

The D-STUDS can also be set for set for following different type of user modes. Automatic alarm mode, in “alarm only” mode, an alarm along with the STUDS ID are sent to the wireless network. Since D-STUDS has fixed optics, bearing and distance to targets are sent as well. All of these messages are low-bandwidth METADATA (a few bytes). Image request mode, in which the D-STUDS will “speak only when spoken to”. In other words, the D-STUDS will only provide an image upon request through the wireless network (possibly activated by a soldier hitting a button on the PDA). Detection mode “trip wire”, in which any and all movement should be detected within a user defined distance from the D-STUDS. A directional trip-wire is settable, enabling alarms from persons approaching the building (not foot traffic perpendicular to the building). People counter mode, in which the algorithm on the D-STUDS should automatically report the number of targets detected. This will provide a good assessment of the potential threat.

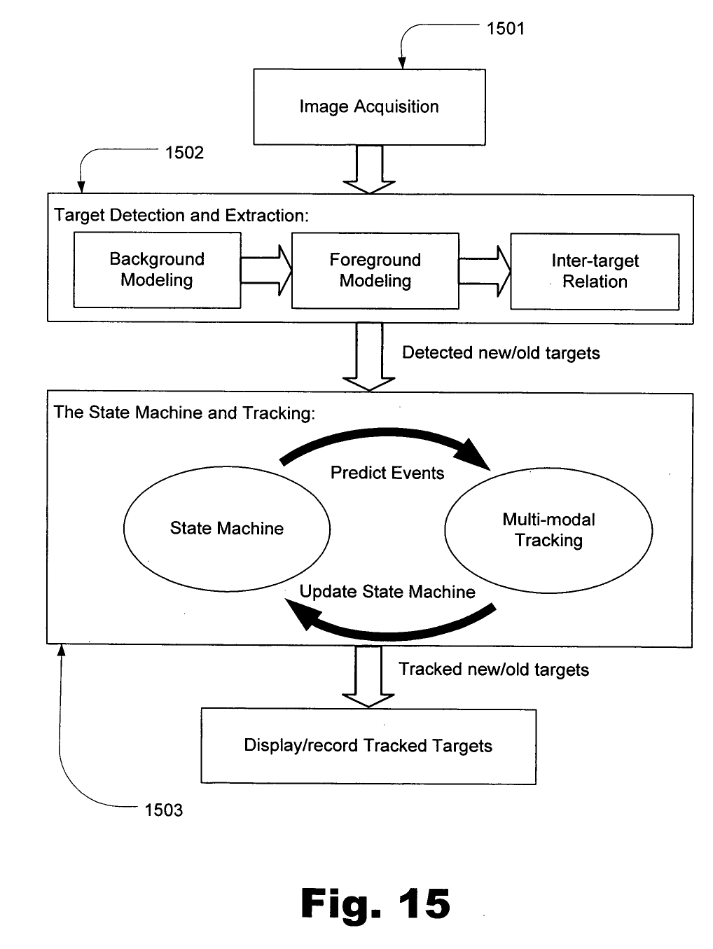

FIG. 15 reiterates the detailed SmartDetect flow chart. As can be seen from this figure, there are three major stages of data processing in the SmartDetect algorithm, namely, feature extraction and tracking (1501), target detection and extraction (1502), and state machine and multi-modal tracking (1503).

Reliable feature extraction and tracking (1501) provide the foundation for target tracking on a moving platform. Without reliable feature tracking (1501), the algorithm will generate many false alarms as well as missed detections.

Target detection and extraction is a probabilistic and deterministic process which generates reliable regions of interest (ROI) of moving/stationary targets. This process however, does not associate targets both spatially and temporally. Thus, the ROIs extracted from this process do not have tracking information.

The state machine and multi-modal tracking is a process (1502) which associates ROIs both within a single frame (spatially) and from frame to frame (temporally)—a real-time tracking process. By processing spatial information from the ROIs generated in the previous process, the state machine predicts events such as target generating, target merging, crossing, splitting, and target disappearing. The multi-modal tracking module takes this information, verifies it and corrects the predicted events. The processed results, in return, update the state machine for the true states of tracked targets. When the SmartDetect algorithm completes the three stages, targets are associated (thus tracked) on each frame and from frame to frame.

In conclusion, the present method and system provides an optical sensor. More specifically, the present specification provides a surveillance system with a computerized data processing apparatus for substantially reducing data transmission bandwidth requirements.

The preceding description has been presented only to illustrate and describe embodiments of the system and method. It is not intended to be exhaustive or to limit the system and method to any precise form disclosed. Many modifications and variations are possible in light of the above teaching.

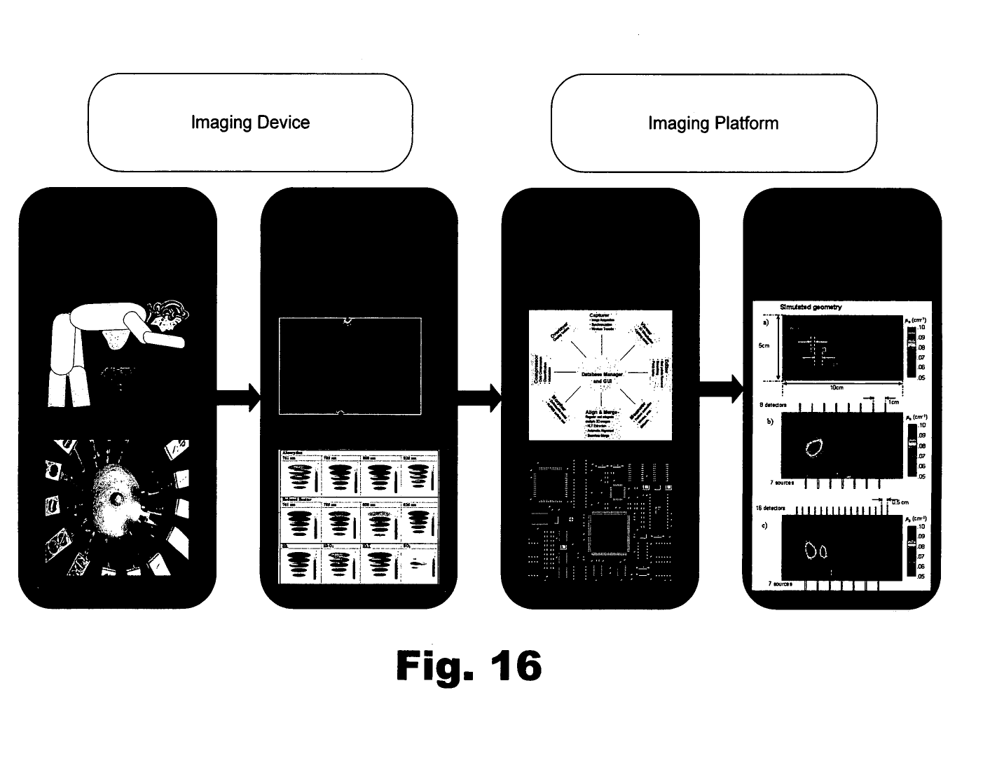

Another possible embodiment of the present system and method is a high-speed medical imaging platform (CORUS) to accelerate the four alternative breast imaging modalities: Magnetic Resonance Elastography (MRE), Electrical Impedance Spectroscopy (EIS), Microwave Imaging Spec-troscopy (MIS), and Near Infrared Spectroscopy (NIS). FIG. 16 shows the concept of the proposed CORUS for multi-modality breast imaging.

The design uses a combination of DSP, FPGA and GPU processors to attain new reconfigurable/programmable cores and real-time computation for 3D medical imaging applications. The platform alleviates the complexities caused by the “random” bus operations using the RAPID-Vbus architecture.

One can implement a real-time parallel FEM algorithm as an example to verify the feasibility of the CORUS architecture. Since the FEM algorithm is widely used in medical imaging and is the computational core of four breast imaging modalities one can implement the FEM onto the current SOS with RAPID-Vbus and integrate a GPU based breadboard in order to measure the improvement in performance.

In Magnetic Resonance Elastography (MRE), mechanical vibrations that are applied to the breast's surface propagate through the breast as a three-dimensional, time-harmonic spatial displacement field varying locally with the mechanical properties of each tissue region. The principal hypothesis underpinning the MRE method is that the mechanical properties of in vivo tissue provide unique information for the detection, characterization, and monitoring of pathology, and tissue hardness is strongly associated with cancer. Although little quantitative work has appeared on the mechanical properties or behavior of breast tissue, measurements of the sono elasticity of masses in rodent prostatectomy specimens have shown good correlations with elasticity.

Magnetic resonance (MR) techniques are used to image this displacement field. These data are used to optimize an FE model of the breast's three-dimensional mechanical property distribution by iteratively refining an initial estimate of that distribution until the model predicts the observed displacements as closely as possible.

There are significant differences between the electrical impedances of the diseased breast tissue and normal breast. The dispersion characteristics of normal and cancerous tissues also differ. These impedance heterogeneities within and around the tumor can be discriminated with Electrical Impedance Spectroscopy (EIS). EIS passes small AC currents through the pendant breast by means of a ring of electrodes placed in contact with the skin. Magnitude and phase measurements of both voltage and current are made simultaneously at all electrodes. The observed patterns of voltage and current are a function of the signals applied and the interior structure of the breast. EIS seeks to optimize an FE model of the spatial distribution of conductivity and permittivity in the breast's interior, using the applied signatures as known inputs and the observed signals as known outputs.

Microwave Imaging Spectroscopy (MIS) interrogates the breast using EM fields. It differs from EIS in using much higher frequencies (i.e., 300-3000 MHz). In this range it is appropriate to treat EM phenomena in terms of wave propagation in the breast rather than voltages and currents.

Like EIS and NIS, MIS surrounds the breast with a circular array of transducers. In this case, these are antennas capable of acting either as transmitters or receivers. Unlike the transducers used in EIS and NIS, however, these are not in direct contact with the breast but are coupled to it through a liquid medium (i.e., the breast is pendant in a liquid-filled tank). Sinusoidal microwave radiation at a fixed frequency is emitted by one antenna and is measured at the other antennas. Each antenna takes its turn as the transmitter until the entire array has been so utilized. As in the other modalities, an FE model of either a two-dimensional slice or a three-dimensional sub-volume of the breast is iteratively adjusted so that the magnitude and phase measurements it predicts using the transmitted waveforms as known inputs converge as closely as possible with those actually observed. The breast properties imaged are permittivity and conductivity, just as in EIS; because of the disjoint frequency ranges employed, however, these properties may serve as proxies for different physiological variables in the two techniques.

In Near Infrared Spectroscopy (NIS), a circular array of optodes (in this case, optical fibers transceiving infrared laser light) is placed in contact with the pendant breast. Each optode in turn is used to illuminate the interior of the breast, serving as a detector when inactive. A two- or three-dimensional FE model of the breast's optical properties is iteratively optimized until simulated observations based on the model converge with observation.

Published data have long supported the notion that near infrared spectroscopy and imaging offer excellent contrast potential. Studies have shown 2:1 contrast between excised tumor and normal breast at certain near infrared wavelengths. Correlations with increase in blood vessel number and size, and characteristic of neovascularization in the tumor periphery leading to a fourfold increase in blood volume have been reported and have been estimated to translate into 4:1 contrast in optical absorption coefficients.

Although each of the imaging modalities discussed above requires unique numerical algorithms and data acquisition hardware, they share a good deal of algorithmic common ground, such as, solution of an inverse problem, non-linear characteristics, and finite element method.

In all modalities, image reconstruction requires the solution of an inverse problem. That is, measurements are made of some physical process (e.g., microwaves, infrared light, or mechanical vibrations) that interacts with the tissue, and from these measurements the two- or three-dimensional distribution of physical properties of the tissue (e.g., dielectric properties, optical absorption coefficient, elasticity) is estimated.

Unlike x-ray computed tomography (CT), where x-rays propagate in nearly straight lines through tissue, all imaging modalities presented here are nonlinear, because the physical interactions are distributed essentially throughout the imaging field-of-view. As a result, the measured response is not a linear function of tissue properties and these properties cannot be determined analytically, but instead necessitate a non-linear model based solution.

Among several numerical approaches for computing the electromagnetic fields or mechanical displacements throughout an inhomogeneous medium, the Finite Element Method (FEM) is particularly useful, and is selected as a solution for all models.

Calculating the effective properties of breast tissue is not a trivial procedure due to their random composition, random phase shape, and widely varying scales. Before any computing may begin, detailed micro-structural information must be in hand, which may be derived from FEM models. Then a 3-D digital image that represents the overall structure of the breast can be constructed.

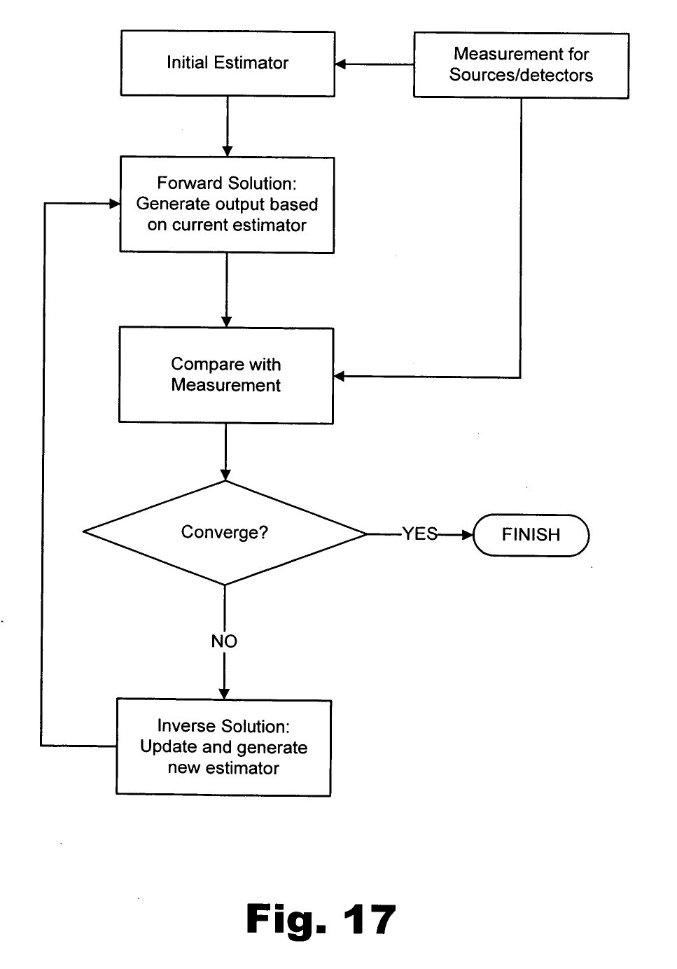

A well-known iterative technique, the Gauss-Newton method, is chosen as the solution of this suite of nonlinear inverse problems. FIG. 17 shows the flow chart of finite element based image reconstruction algorithm. The procedures are listed as follows:
1. Determine an initial estimate of the spatial distribution of the tissue's physical properties;
2. Calculate the response that would be observed based on this initial distribution (i.e., solve the “forward problem”);
3. Compare these calculated observations to the actual observed data;
4. Update the estimated property distribution accordingly.
5. This process is iterated until the real and calculated observations converge.
6. After convergence, the final estimated distribution is taken as the desired image.

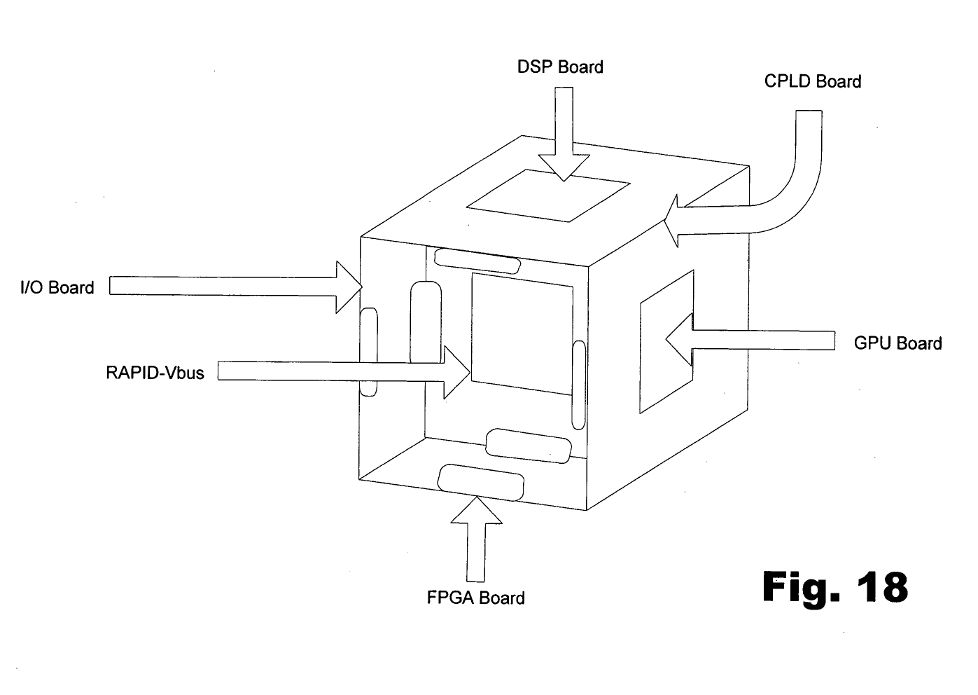

The hardware architecture for the CORUS is illustrated in FIG. 18.

The RAPID-Vbus provides the flexible real-time matrix inter-connects described in FIG. 13. As can be observed, each card (board) of the CORUS has multiple data ports which allow the data input through multiple sensors. These ports may be used for data, video and audio. In our particular example the ports are used to collect data from sensors in different imaging modalities. Note that each port has two halves, “A” and “B”, and that “B-A” means connect the “B” port from the row on the left to the “A” port from the column on top. The advantage of this design is that the data port interconnect is a hardware function that is completely controlled by software. Thus, algorithms are easily configured and reconfigured as often as the development process requires, while making the final co-processor integration effort as simple as filling the above chart.

In addition, embedding algorithms onto each of the three processor platforms is fast and easy thanks to advanced use of available tools. All control plane operation, such as time-stamping data collection, and recording onto a USB 2.0 device are conducted on the DSP using TI's DSP/BIOS real-time OS kernel. By taking this approach one not only has a free real-time micro-kernel, but one also can develop all of the drivers, and DSP algorithms using a single Integrated Development Environment (IDE): TI's Code Composer Studio. Moreover, since there is a FPGA with a RISC processor available on the CORUS platform, one never has to optimize DSP code using assembly. All CORUS programming can be done using the C language. Even programming the FPGA and RISC processor is done using a flavor of the C language, called Handel-C. As a result all CORUS programming can be done using C, with the use of two IDEs. All co-processor communication is handled by the RAPID-Vbus, leading to zero final co-processor integration time.

After task assignment among processors, now there is a need to partition the data partition for the parallel calculation. In a parallel environment with a set of N processors, the program is typically set up such that one processor is arbitrarily selected as the root node (rank=0) and the others as workers (rank=1 . . . N−1). Root is in charge of the I/O, assigning data to the workers through Messaging Program Interface (MPI) and calculating its assigned task. The user does not actually assign the root or worker identity to any specific processor in the cluster, and it is the operating system's duty to carry it out.

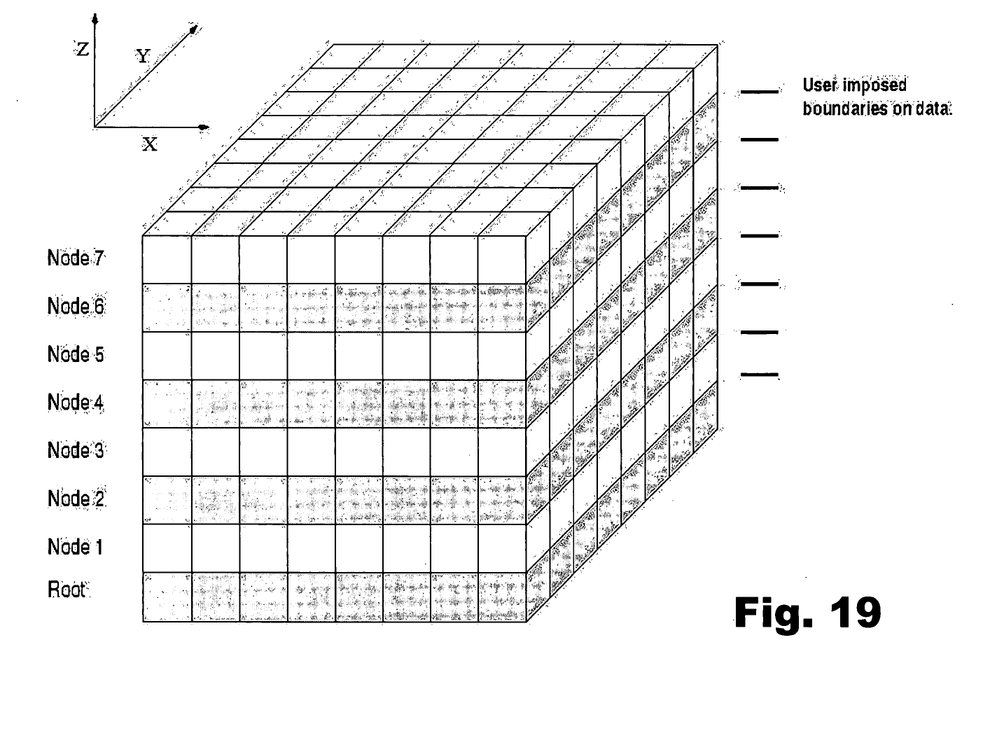

Each matrix element can be calculated individually and independently from each other. So these parallel programs take advantage of the 3-D nature of the data (stored in array pix) by splitting it (along the z-direction) across multiple processing nodes. Each matrix element is addressed by a unique triplet of (x, y, z) coordinates and only portions (z-specific) of these large arrays exist on all the processors. This data is divided as evenly as possible over N compute nodes in the z direction so each processing node only has to dedicate 1/N the amount of memory to data storage for an equivalent sized problem on a serial machine; and theoretically, this calculation should speed up by a factor of N the amount of time to execute the same problem on a serial based machine. Additionally, problems which are N times as large can be run as well. FIG. 19 shows the data is divided into 8 layers with the amount of memory to data storage for an equivalent sized problem on a serial machine.

The inherent question after splitting the original data across a number of processing nodes has to do with if a node has all the data it needs to carry out its assigned tasks. These problems need nearest neighbor information and they cannot have the required data after the initial split due to the user imposed boundaries on the dataset. Therefore inter-node communication (data transfer) is necessary. This requires the processors to know which nodes have the data they need and a mechanism for the data transfer.

Since a voxel needs information from its nearest neighbors to perform a correct calculation, problems arise when a processor attempts to calculate using a voxel located in either its top layer (z=d2) or its bottom layer (z=d1). Since this problem arises for all voxels in their respective d1 or d2 layers, a given node will need an entire data slice (one 2-d array) from its north and south neighbors, respectively. To be exact, processor P needs the south node (P−1) to send its values of pix(i, j, d2) and the north node (P+1) to send its values of pix(i, j, d1).

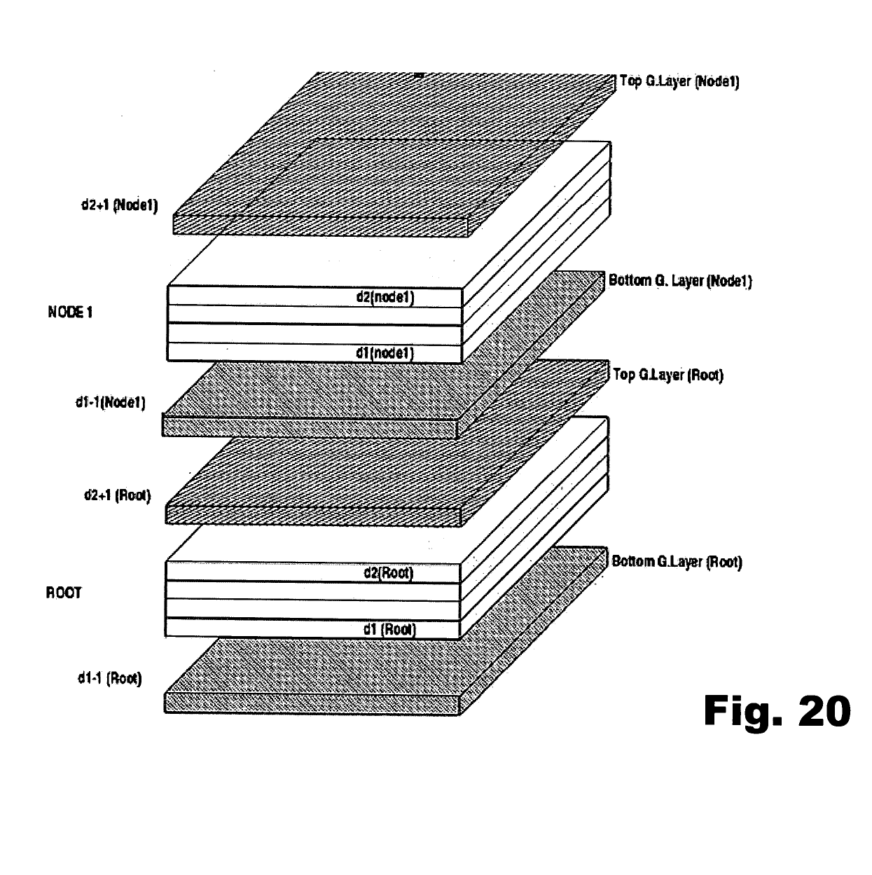

The preferred way for handling this situation is to increase the z-size of the array on each node by 2. The new layers occupy k=d1−1 and k=d2+1 per processor. They are referred to commonly as ghost layers and are depicted in FIG. 20. These layers are created before any of the calculations proceed since pix does not change during a calculation. This method allows the calculations to proceed uninterrupted unless global sums or other similar actions are called for.

This makes the total amount of memory usage per node increase slightly. However, it obviates the need for additional inter-node communication during a given calculation that would increase the overall run time of the job.

This situation gives rise to two special cases, namely what is considered south of processor 0 and north of processor N−1. The key to this is to know that the original data, pix, has periodic boundary conditions and behaves in a cyclic fashion. Therefore, south of processor 0 is processor N−1 and north of processor N−1 is processor 0. This leads to the following assignments.

Root is the only processor which needs the entire pix array since it must pass out specific allotments to the workers. In conjunction with the memory release, the memory used for pix is released after all passing of data is complete. Also voxel is defined by its d1 and d2 limits and not the entire value. This small range is at the heart of defining subsections of arrays per processor for parallel computations. Furthermore, this type of memory allocation used with the array voxel is applied to all the large arrays found throughout all the programs.

In the finite element programs, each voxel must know the positions of its 27 nearest neighbors in a cubic array since that is a mathematical requirement of the calculation. Each voxel is dimensioned as a rank 3 array, vox(nx, ny, d1−1: d2+1). With this arrangement, it is trivial to find the indices of 27 nearest neighbors for a given voxel, vox(i, j, k). The three nearest neighbors (including the voxel itself) in the z-direction have indices of (i, j, k−1), (i, j, k) and (i, j, k+1). Therefore the set of 27 nearest neighbors for this element is generated by adding ±1 or 0 to any or all of the indices of the (i, j, k) triplet. The lowest neighbor has indices of (i−1, j−1, k−1) and the highest has (i+1, j+1, k+1). These values can be calculated on the fly or generated by using an adequately defined set of triply nested do-loops.

Special allowances have to be made when the current voxel is on the outside edges of the data cube (i.e. i=1 or nx or j=1 or ny). At these extremes, the value of i or j is interrogated and the values of i−1, i+1 are compared to 0 and nx. For example, if i−i (or j−1) equals 0, a modification takes place and the (i−1)th (or (j−1)th) neighbor is replaced by the voxel with i=nx (or j=ny). A similar modification takes place when the voxel having i=nx (j=ny). In this instance, the voxel with i=1 (or j=1) is used. This procedure is justified due to the periodic nature of the data.

Therefore, by switching over to a parallel implementation and this new indexing scheme, one has a dramatic improvement in memory savings since the additional storage of particle positions is no longer needed. This memory is now free to be put to better use.

Some small arrays that appear throughout the calculations have dimensions that are determined by the number of phases one has in the original dataset; this number is known a-priori, like nx, ny and nz. Arrays which need this value are pre-defined as well. This increases the flexibility of the program and contributes to a saving of memory by implementing dynamic allocation of additional arrays.

What is claimed is:

1. An improved optical sensor comprising:
at least one optical camera for collecting intelligence data,
a control station associated with at least one of said cameras for detecting activities to be monitored and for selectively activating at least one of said cameras, and
a computerized data processing apparatus for substantially reducing data transmission bandwidth requirements by preprocessing at least some of said intelligence data at said camera site before transmission from said surveillance camera to one or more remote control stations.

2. The optical sensor of claim 1, wherein the camera comprises either a video camera or an IR camera.

3. The optical sensor of claim 1, wherein said data processing apparatus further comprises programmatic algorithms to selectively facilitate wireless links between one or more of said cameras and said control stations.

4. The optical sensor of claim 1, wherein said optical camera additionally comprises an adhesive in order to attach said camera to a surface.

5. The optical sensor of claim 1, wherein said optical camera additionally comprises a Global Positioning Satellite (GPS) system to identify the position of said optical camera.

6. A video surveillance system comprising:
an array of closed-circuit (CCTV) cameras,
an array of computerized image processors individually associated with one of said cameras in a distributed computing architecture, and
a selectable array of algorithms for enabling any single said image processors to pre-process surveillance data from its associated camera to significantly reduce data transmission bandwidth requirements to facilitate improved video data transmission from said individual cameras to selectable ones of said control stations.

7. The video surveillance system of claim 6, additionally comprising transmission means for selectively remotely downloading additional algorithms to said individual camera platforms of said system.

8. The surveillance system of claim 6, wherein said cameras comprise additional sensors selected from the group consisting of seismic, Infrared (IR) beam, acoustic, Radio Detection And Ranging (RADAR) and lasers to act as primary or redundant sensors.

9. The surveillance system of claim 8, wherein said additional sensors will actuate said surveillance system after motion has been detected.

10. The video surveillance system of claim 6, wherein said system will conserve energy by initiating a hard sleep mode, a soft sleep mode, or a full operation mode depending on preset operation parameters.

11. The video surveillance system of claim 6, wherein said camera additionally comprises an adhesive in order to attach said camera to a surface.

12. The video surveillance system of claim 6, wherein said camera additionally comprises a Global Positioning Satellite (GPS) system to identify the position of said optical camera.

13. A process for improving the efficiency of the collection of surveillance data comprising the steps of:
selectively positioning a plurality of smart surveillance platforms to generate intelligence data to be gathered,
positioning one or more control stations in operative proximity to said surveillance platforms to gather said intelligence data, and
combining computational smart video processing algorithms with an individual one of said surveillance cameras mounted on each of said platforms whereby the transmission bandwidth requirements may be significantly reduced before intelligence data is transmitted from said surveillance platforms to said control stations.

14. The process of claim 13, wherein the step of generating said intelligence data comprises the step of selectively activating at least one video camera or at least one IR camera mounted on one of said surveillance platforms.

15. The process of claim 14, additionally including a step of activating a motion detector associated with one or more said surveillance cameras to selectively activate at least one of said cameras.

16. The process of claim 13, wherein the step of combining computational smart video processing algorithms with an individual one of said surveillance cameras includes an additional step of downloading algorithmic computer programs to at least one of said platforms to facilitate additional programmatic features such as wireless transmission, for transmitting intelligence data from said platforms to said control stations.

17. The process of claim 13, wherein the step of selectively positioning a plurality of smart surveillance platforms includes applying an adhesive to said surveillance camera in order to attach said surveillance camera to a surface.

18. The process claim 13, wherein the step of selectively positioning a plurality of smart surveillance platforms includes adding a Global Positioning Satellite (GPS) system to surveillance platforms in order to identify the position of said surveillance platforms.

19. The process claim 18, wherein the step of adding a Global Positioning Satellite (GPS) system to surveillance platforms additionally includes transmission means to transmit said positions of said surveillance platforms to a personal portable user interface.

20. The process of claim 13, wherein said smart surveillance platforms will conserve energy by initiating a hard sleep mode, a soft sleep mode, or a full operation mode depending on preset operation parameters.
